(19) United States
(12) Patent Application Publication
(10) Pub. No.: US 2013/0179236 A1
(43) Pub. Date: Jul. 11, 2013

(54) COMPUTERIZED METHOD AND SYSTEM FOR ENHANCING THE SALES PERFORMANCE OF SELECTED SALES FORCE PROFESSIONALS

(71) Applicant: The Corporate Executive Board Company, Arlington, VA (US)

(72) Inventors: Timur HICYILMAZ, Washington, DC (US); Matthew DIXON, Silver Spring, MD (US); Brent M. ADAMSON, Leesburg, VA (US); Todd Andrew BURNER, Arlington, VA (US); Karen Eisner FREEMAN, Arlington, VA (US)

(73) Assignee: THE CORPORATE EXECUTIVE BOARD COMPANY, Arlington, VA (US)

(21) Appl. No.: 13/738,187

(22) Filed: Jan. 10, 2013

Related U.S. Application Data
(60) Provisional application No. 61/632,824, filed on Jan. 10, 2012.

(51) Int. Cl. G06Q 10/06

(52) U.S. Cl. CPC G06Q 10/06398
USPC 705/7.42

(57) ABSTRACT

Disclosed are computerized methods and systems for enhancing the sales performance of selected sales force professionals comprising assessing a plurality of sales reps along various objective and subjective dimensions (including sales performance information) and generating, for each such sales rep, an associated sales rep record; and comparing each such sales rep record to a computer database of high-performing sales rep records to identify, for each selected sales rep, those dimensions which by improving will, based on the organization's sales culture (determined by the aggregate of sales rep records), better align such sales rep record with high-performing sales rep records. Moreover, other important features are disclosed, and examples given.

This application claims the benefit of U.S. Provisional Application No. 61/632,824 filed Jan. 10, 2012, the entirety of which is hereby incorporated by reference.

### FIELD OF THE INVENTION

The invention disclosed herein generally relates to computerized techniques for assessing sales force professionals, and, in particular, to computerized techniques for enhancing the sales performance of selected sales force professionals, and thereby, organizational sales performance, based on such assessments.

### COPYRIGHT AUTHORIZATION

A portion of this disclosure contains material that is subject to copyright protection. The copyright owner has no objection to the copying of this disclosure, as it appears in the Patent and Trademark Office patent file or records, by anyone but otherwise reserves all copyright or other rights whatsoever.

### BACKGROUND OF THE INVENTION

The continued commercial success of a company strongly depends on its sales force's ability to retain existing customers and to continue to acquire new customers, and importantly, to sell products or services to such customers. However, companies generally find huge variation in terms of how well different groups and individuals perform these functions. Sales force effectiveness is therefore a prime concern for most businesses.

In addition, selling products and services is an increasingly complex task. Economic fluctuations, increased competition, commoditization of products and services, and continued customer and vendor globalization combined with increased reliance on professional procurement functions are creating more and more challenges on sales professionals and managers. In order to be successful, a business's sales performance must be continually improved.

As a result, in a typical business environment, periodic sales performance assessments are conducted to monitor the progress and growth of the business and to identify areas of strength and flag potential weaknesses among the sales force. Such assessments typically take the form of objective metrics, such as sales data outlining generated revenue, for example, the gross receipts or the net profit of a particular store, sales group or individual sales force professional (sales rep). At least one benefit from the current objective assessment techniques (and their primary result) is to rank by sales performance particular stores, sales groups and individual sales reps. Yet, these objective assessments do not provide insights into why a particular store, sales group or individual sales rep is ranked highly, while another is not.

Once ranked, a business faces the problem of raising the performance of the lower ranks, and, perhaps to a lesser extent, providing additional support to the upper ranks of sales performers (whether ranked by particular store, sales group or individual sales force professionals). Given the potential benefits from being able to raise the performance of lower ranked performers, particularly those lower ranked individual sales reps already employed by a business, businesses spend considerable sums of money to maintain—and hopefully improve—the productivity of their sales forces. However, returns on these investments have generally failed to match the returns in other kinds of process improvements investments businesses make. Businesses thus find themselves having to pay ever higher amounts for top performing sales professionals without really knowing why some people are top performers and others are not.

This inefficiency continues despite extensive amounts of work done in order to predict competencies and explain general performance (including management performance and sales performance) of employees, using both objective and subjective assessments (often in the form of an arbitrary scale along a defined dimension). Frank L. Schmidt and John E. Hunter summarize findings from 85 years of research in their 1998 paper “The Validity and Utility of Selection Methods in Personnel Psychology: Practical and Theoretical Implications of 85 Years of Research Findings,” which disclosure is hereby incorporated by reference.

Current efforts at gaining an understanding of sales force professionals generally use a combination of the methods described by Schmidt and Hunter (i.e., general intelligence testing, work sample testing, and integrity testing, as well as subjective questionnaires and structured interviews). While intelligence tests are found to be good overall predictors of baseline success and the ability to learn new skills, these tests are time-consuming, are generally regarded as being intrusive and often fail to provide a business with any information they could not have gleaned by asking for people's test results at general aptitude tests such as the SATs. And because the local results for a company will not be substantially different from the predicted global result—and are generally only slightly correlated with high sales performance—they fail to provide companies with differentiated insight.

Structured interviews substantially leverage work conducted by David C. McClelland during the 1970s. McClelland's work on “Behavioral Event Interviewing” asks people known to have performed a job well or poorly to “describe situations in which things turned out well or poorly and then to describe these situations in exhaustive narrative detail.” Transcripts of interviews are then analyzed to find underlying behaviors shown by superior performers and not shown by average performers. The structured interview method does, however, require a considerable investment in the training and “norming” (i.e., establishing a normalization process) of interviewers. Since the method is essentially qualitative and depends on observing differences in narrative, there is also a need to interview high and core performers in any new situation in order to discover behavioral differences. In practical terms, there is no easy way to establish uniform, predictive dimensions across a variety of typical situations.

There are also several methods that attempt to link sales person performance to widely known personality inventories such as the “Big Five Model” (or Five Factor Model) originally proposed by Ernest Tupes and Raymond Cristal in the 1960s. This construct describes individuals in terms of 5 factors: Openness, Conscientiousness, Extraversion, Agreeableness, and Neuroticism. While this inventory is a very stable construct, in practice it is better at predicting failure than the difference between competent and overall success (i.e., only low scores are predictive). This makes the method less useful in terms of assessing individuals with more complex roles, and the literature finds little to no connection between somebody's stated “interests” and their ability to perform certain roles. Pure personality, in other words, might explain why somebody might want to try to be a successful sales person but ambition alone will not predict success.

Typical periodic assessments, in any of the forms discussed, moreover, do not provide specific guidance to a business on how to develop and implement known sales performance enhancement techniques (e.g., formal training and proactive skill development). In general, known methods are only useful only to categorize sales force professionals (usually along specified given dimensions), and generally do not imply any course of sales performance enhancement actions. While one may determine those dimensions most highly correlated with high sales performance (success), and seek to train their Sales reps accordingly, an organization's or sales rep's sales culture is not likely to be subject to dramatic change by merely implementing a course of training and skills development.

The present invention satisfies a need for a system and method that can (i) describe the current sales culture of a business, whether as a whole, by particular store, sales group or individual sales force professional, (ii) effectively characterize the strengths and weaknesses of a particular store, sales group or individual sales rep that comprise a business's sales force viz a viz the sales culture, and (iii) inform business managers on training and development efforts that should likely provide a tangible benefit given the business's sales culture and sales environment, (iv) preferably provides sales rep-specific (or other group-specific) feedback and direction to tangibly enhance sales performance, and (v) optimally be used in an iterative manner to continually develop sales performance skills and knowledge. Such a system and method will increase sales force productivity and efficiency, which in turn increases sales and revenue and allows a business to grow.

Still other objects and advantages of the invention will in part be obvious and will in part be apparent from the disclosure herein provided.

### SUMMARY OF THE INVENTION

Disclosed are computerized methods and systems for enhancing the sales performance of selected sales force professionals comprising assessing a plurality of sales reps along various objective and subjective dimensions (including sales performance information) and generating, for each such sales rep, an associated sales rep record; and comparing each such sales rep record to a computer database of high-performing sales rep records to identify, for each selected sales rep, those dimensions which by improving will, based on the organization's sales culture (determined by the aggregate of sales rep records), better align such sales rep record with high-performing sales rep records. Moreover, other important features are disclosed, and examples given. Without limiting the foregoing, or the scope of the claims attached hereto, the invention comprises the following embodiments.

A computerized method for enhancing the sales performance of selected sales force professionals includes the step of providing a computerized database for storing one or more sales rep records, each sales rep record including one or more dimensions and associated dimension scores. The dimensions are generally one or more objective and/or subjective dimensions, and or dimensions derived from combining other dimension scores.

The sales rep records also include, for each high-performing sales rep, one or more high-performance indicators, which may be as simple as a checkbox, or may include one or more dimension scores (especially, derived combo dimension) meeting or exceeding a predetermined value along the associated dimension indicative of a high-performing sales rep, such as revenue or profit attainment numbers. The database will generally be populated with predetermined sales rep records corresponding to predetermined high-performing sales reps.

The method also includes the step of conducting a sales rep assessment survey, and generating for each assessed sales rep from among a plurality of sales reps to be assessed a computerized assessed sales rep record for said assessed sales rep generally including one or more individual dimension score obtained from such surveys, each said individual dimension score representing an assessment of said assessed sales rep along the associated dimension.

The method also includes the step of comparing, by computerized methods, each said assessed sales rep record to said predetermined high performing sales rep records to determine whether any individual dimension scores for said assessed sales rep record meet or exceed a predetermined value along the associated dimension indicative of a high-performing sales rep.

The method also includes the step of generating one or more computerized reports including one or more indicators of specific dimensions for said assessed sales reps, based on the organization's dominant sales culture (determined by the aggregate of sales rep records), said specific dimensions representing those dimension which by incremental improvement in the associated dimension scores will improve the alignment of said assessed sales rep record with said high-performing sales rep records, and one or more indicators of a predetermined course of action to be followed in order to effect incremental improvement of said assessed sales reps in the associated dimension scores.

A computerized system for enhancing the sales performance of selected sales force professionals includes a computerized database for storing one or more sales rep records, each sales rep record including one or more dimensions and associated dimension scores. The dimensions include objective and/or subjective dimensions, and, dimensions derived from combining other dimension scores.

The sales rep records also include, for each high-performing sales rep, one or more high-performance indicators, which may be as simple as a checkbox, or may include one or more dimension scores (particularly a derived combo dimension) meeting or exceeding a predetermined value along the associated dimension indicative of a high-performing sales rep. The database will generally be populated with one or more predetermined sales rep records including one or more sales rep records corresponding to a predetermined high-performing sales rep based on revenue or profit attainment numbers.

The computerized system also includes a computerized survey form for obtaining, for each assessed sales rep from among a plurality of sales reps to be assessed, selected dimension scores for said assessed sales reps; and generating, from such dimension scores, an assessed sales rep record for said assessed sales rep including one or more individual derived combination dimension scores representing a sales type (in accordance with a pre-selected construct), each said individual derived dimension score representing an assessment of said assessed sales rep along the associated dimension.

The computerized system also includes a computer program implementing algorithms and control logic for comparing each said assessed sales rep record to said predetermined high performing sales rep records to determine whether any individual dimension scores for said assessed sales rep record meet or exceed a predetermined value along the associated dimension indicative of a high-performing sales rep.

Embodiments of the present invention may also be characterized as a computerized method for assessing and enhancing the sales performance of selected sales force professionals, comprising the following several steps: providing a computerized database for storing a plurality of sales rep records, each sales rep record including one or more dimensions for storing associated dimension scores; populating said database with dimension scores representative of a plurality of sales reps, including dimension scores representative of a high-performing sales rep; assessing, with a processor, each sales rep record from among the plurality of sales rep records yielding assessed sales reps by comparing dimension scores of each sales rep record to the dimension scores representative of a high performing sales rep to determine a sales profile type of each sales rep, and, for a given sales rep, whether any dimension scores for said given sales rep meet or exceed a value indicative of a high performing sales rep; and generating, based on the sales rep records, one or more computerized reports comprising one or more indicators of sales profile type associated with respective assessed sales reps, one or more indicators of specific dimensions for said respective assessed sales reps representing those dimensions which by incremental improvement in the associated dimension scores will improve alignment of said respective assessed sales reps with said high-performing sales reps in view of sales profile type for said respective assessed sales reps. The foregoing methodology may be implemented using a computer or processor operating in accordance with logic or software instructions that, when executed by the computer or processor perform the indicated steps.

The invention accordingly comprises the several steps and the relation of one or more of such steps with respect to each of the others, and the system embodying features of construction, combinations of elements and arrangements of parts which are adapted to effect such steps, all as exemplified in the following detailed disclosure, and the scope of the invention will be indicated in the claims.

### BRIEF DESCRIPTION OF THE DRAWINGS

For a fuller understanding of the invention, reference is had to the following description taken in connection with the accompanying drawings, in which:

FIG. 1A is a schematic block diagram illustrating a method for implementing embodiments described herein;

FIG. 1B is an example database structure showing sales rep records and associated dimensions.

FIGS. 2A-2U show a representative survey in accordance with a preferred embodiment;

FIG. 3 shows selected details about the different sales rep profile types;

FIG. 4 shows a chart displaying the beta, or impact on performance of a one unit change in selected categories of attributes;

FIG. 5 shows a chart displaying a comparison of skill/behavior drivers;

FIG. 6 shows a chart displaying a comparison of attitude drivers; and

FIG. 7 shows a chart displaying the impact on performance of moving from the 25th to the 75th percentile in the attributes of each profile type.

FIG. 8 is a schematic block diagram illustrating a method according to another embodiment described herein

FIG. 9 depicts an exemplary computer system through which embodiments described herein may be implemented.

### DETAILED DESCRIPTION OF EMBODIMENTS

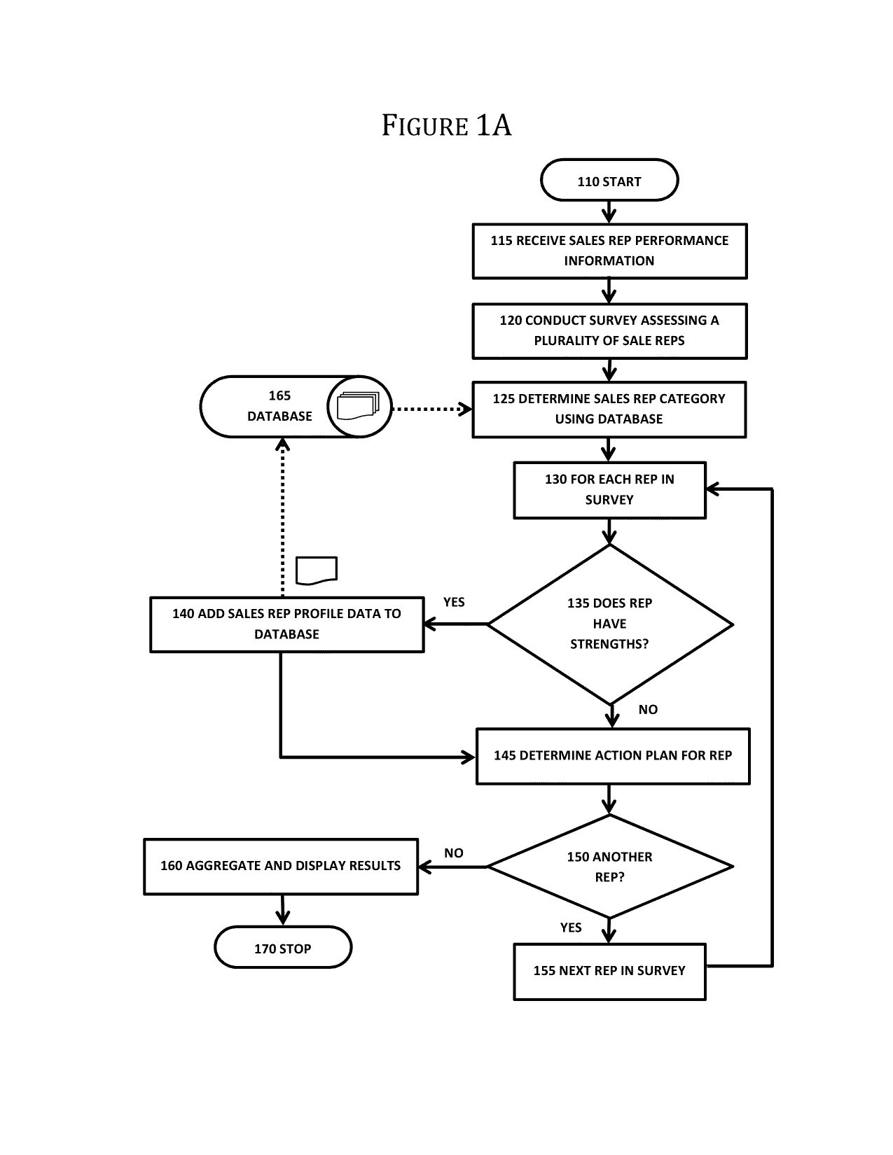

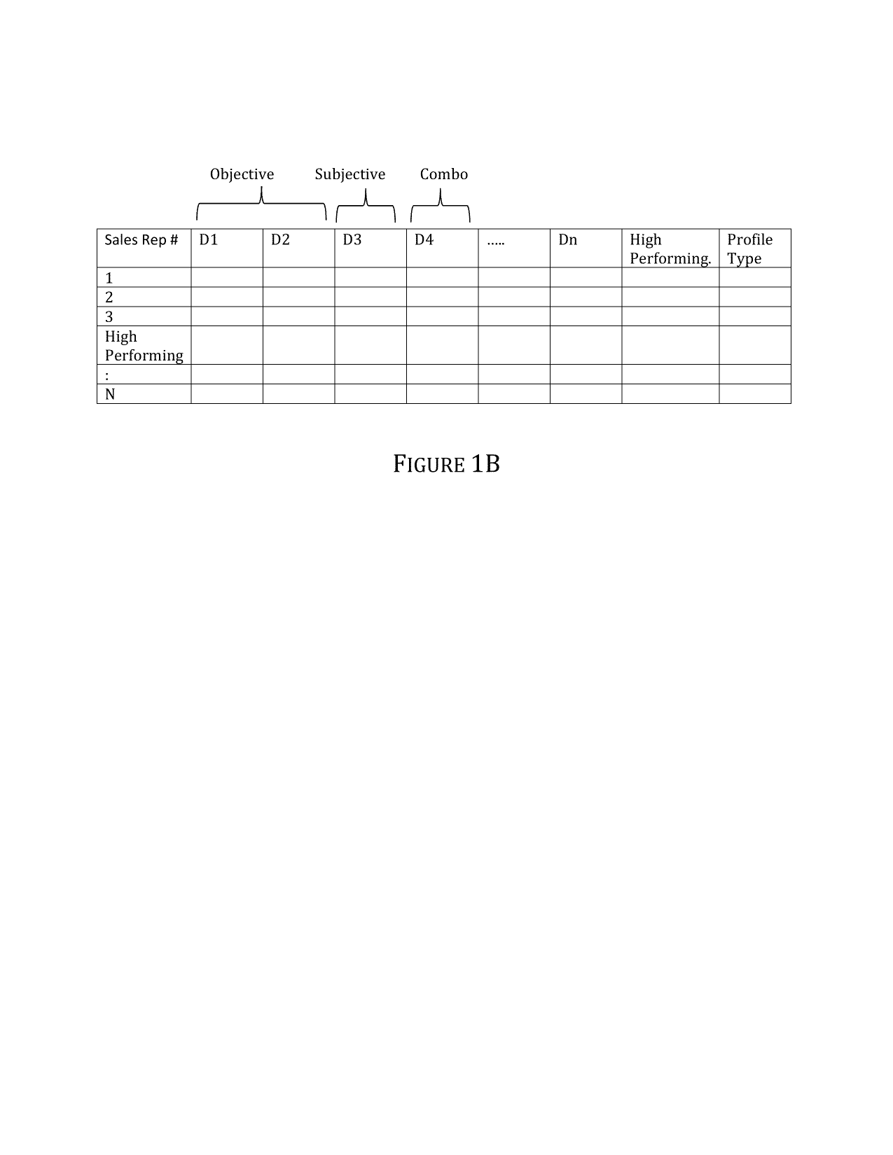

This invention provides repeatable and reproducible techniques, and systems for implementing such techniques, for assessing individual sales professional's sales performance and providing sales performance enhancements in a manner that satisfies the objects described above. Reference is had to FIG. 1A, generally showing a schematic block diagram illustrating a method for implementing embodiments as described herein. The method begins at start 110, generally by running a computerized application, such as a database or spreadsheet application. Alternatively, the method can be implemented by accessing a webpage or hosted service, which will advantageously be secured, personalized and generally private by utilizing known Internet security and login measures. Alternatively, the method can be implemented by accessing a mobile app on a cell phone or tablet or other mobile device (laptop or netbook).

As shown if FIG. 1B, the computer application will generally include or provide access to a computerized database or spreadsheet for storing a plurality of sales professional records. These records will generally comprise one or more dimensions (D1, D2, . . . , Dn) in which a score for that dimension is recorded. The dimensions are one of, as indicated, (i) objective measures (such as years of selling, sales or profit attainment numbers), (ii) subjective evaluations (the ability to work independently, problem-solving ingenuity), and (iii) dimensions derived from a combination of other dimensions; and preferably all three. Although only one or two of each dimension type are depicted in the simplified example database structure of FIG. 1B, those skilled in the art will appreciate that any number of individual fields or dimensions can be arranged or associated with a given dimension type (i.e., objective, subjective, combination). The dimensions will generally conform to a construct useful for assessing sales performance and for determining sales performance enhancement techniques applicable to selected assessed sales professionals.

For this reason, the sales professional records will generally include, for each high-performing sales rep, one or more high-performance indicators. This can be, as depicted in FIG. 1B, as simple as a binary database field (e.g., “yes” they are high performers or “no” they are not high performers) to more typically, objective sales performance metrics being stored as dimension scores (i.e., meeting or exceeding an arbitrary number, or falling in the top portion of the company's sales performance distribution curve). Ideally, a combination of dimensions will be identified whose combination of dimension scores meet or exceed a predetermined value along the associated dimension indicative of a high-performing sales rep.

Advantageously the system database will be populated with a plurality of predetermined sales rep records, including a plurality of sales rep records corresponding to high-performing sales reps, for example, from the historical data collected while using the system. It is a further advantage to include in the database sales rep records categorized and indicative of high performing sales reps within differing sales cultures (as defined by a pre-determined sales-culture construct). Optionally or in addition, exemplar high-performing sales professional records will be arbitrarily added to the database in accordance with the underlying construct.

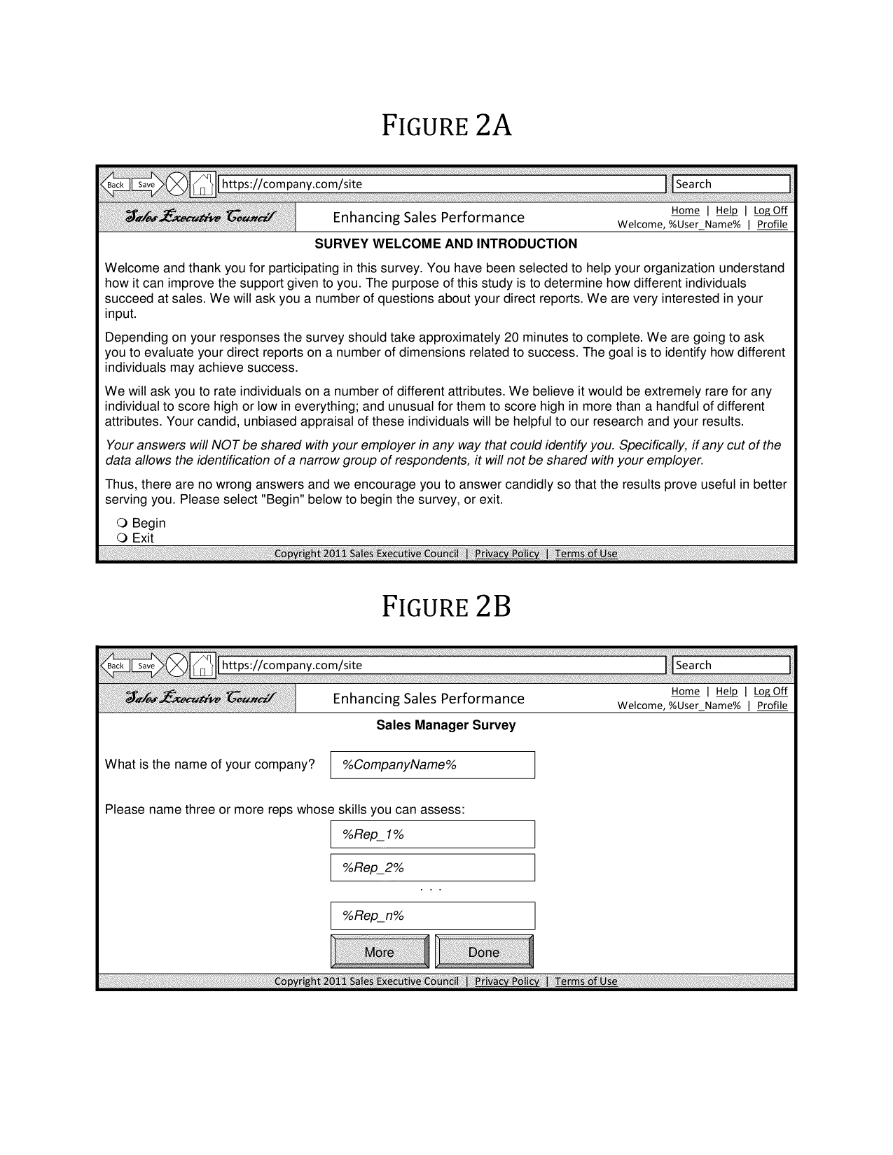

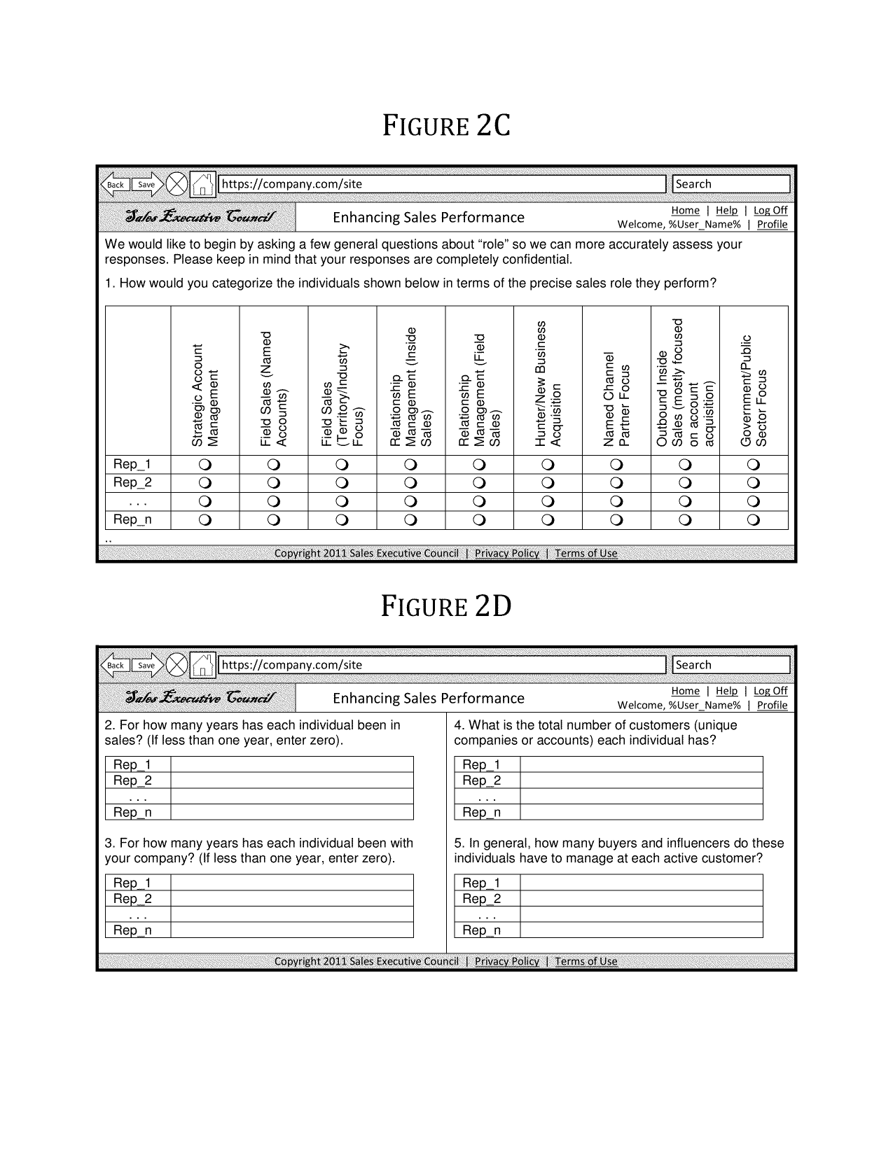

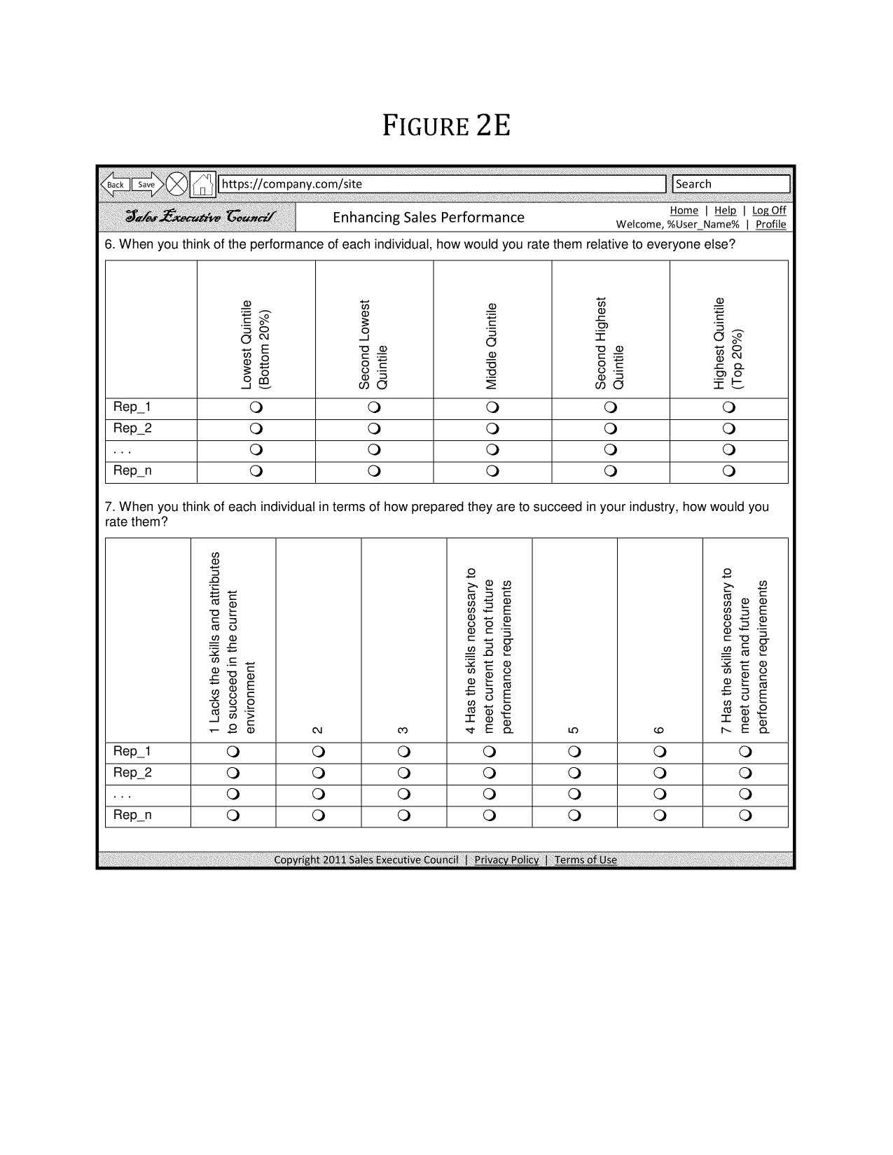

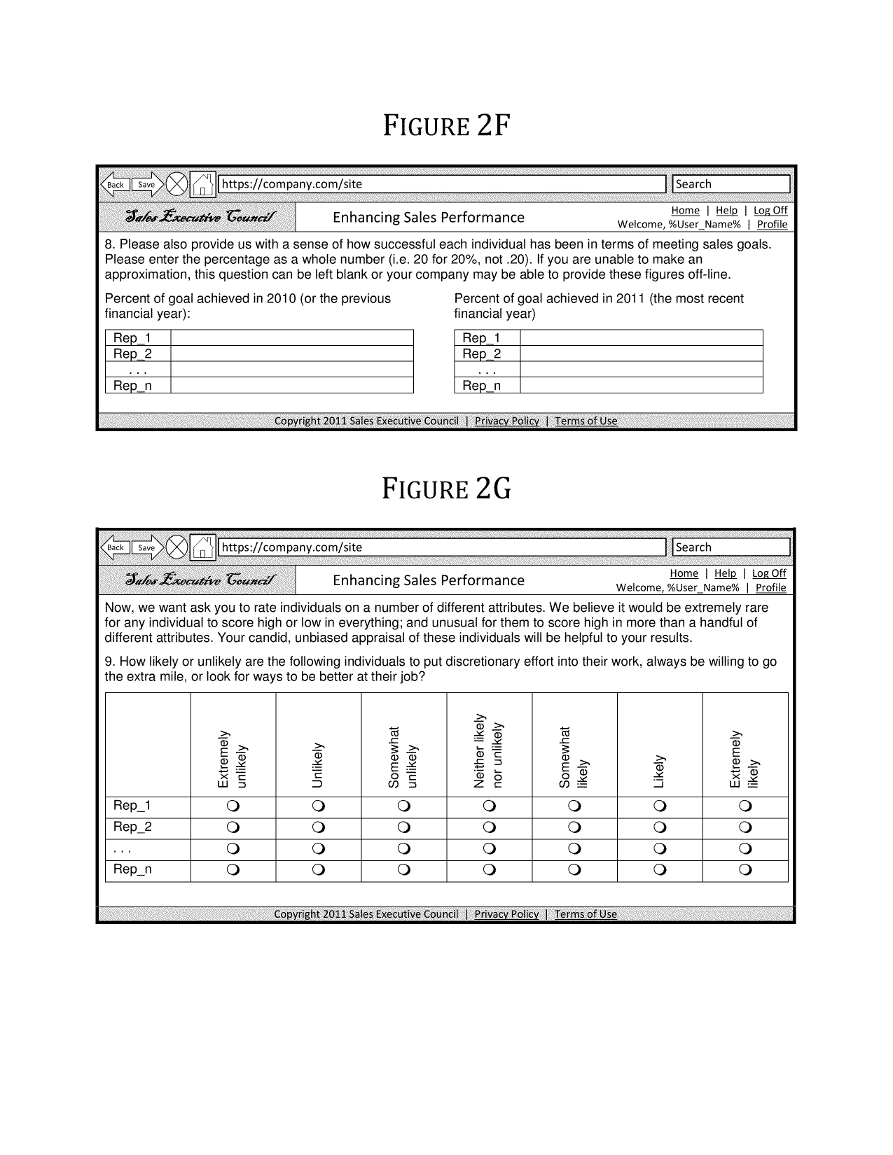

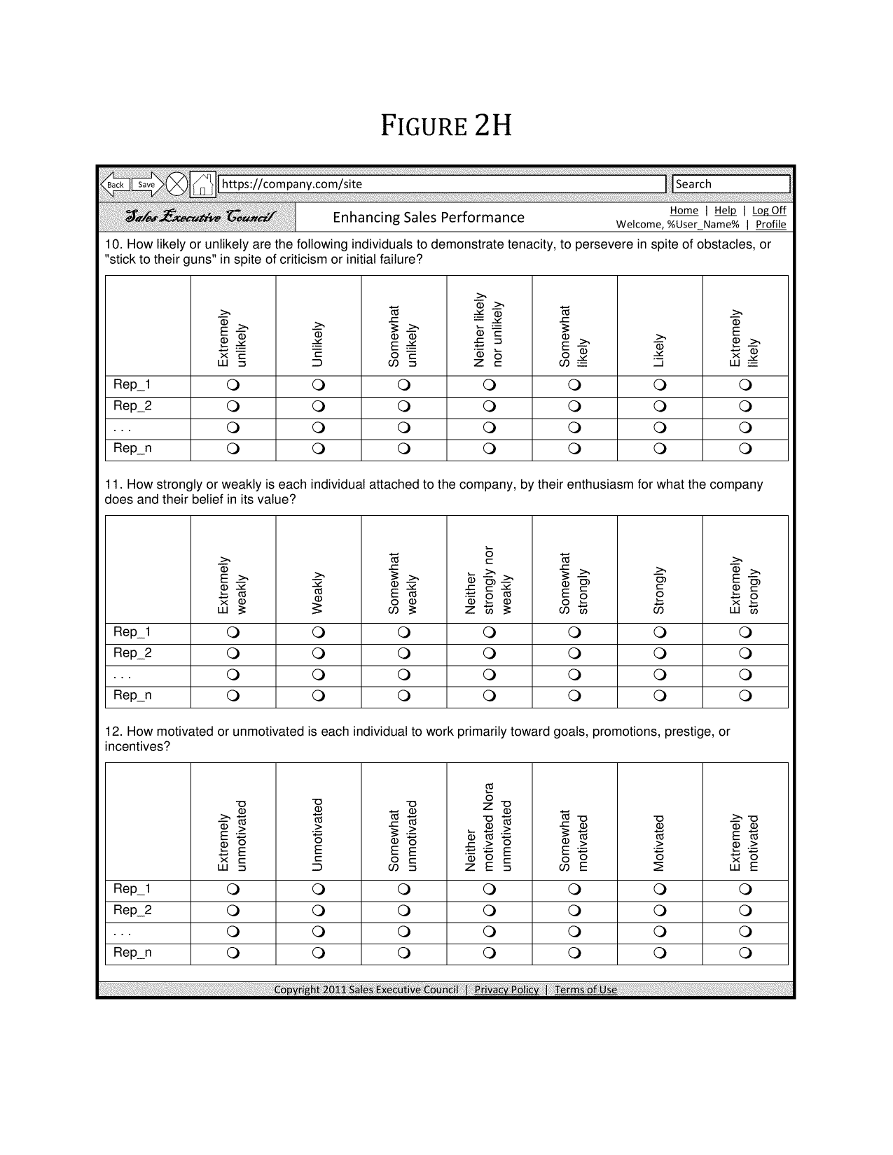

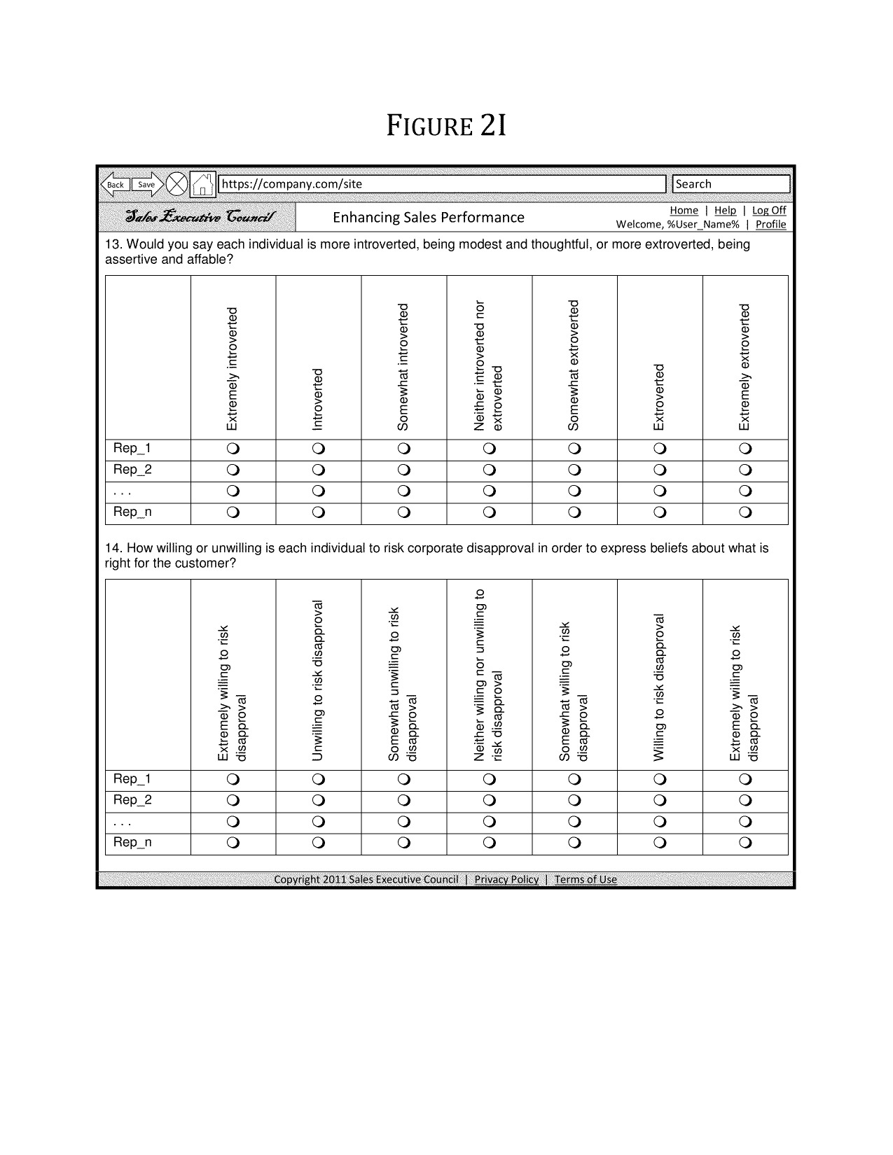

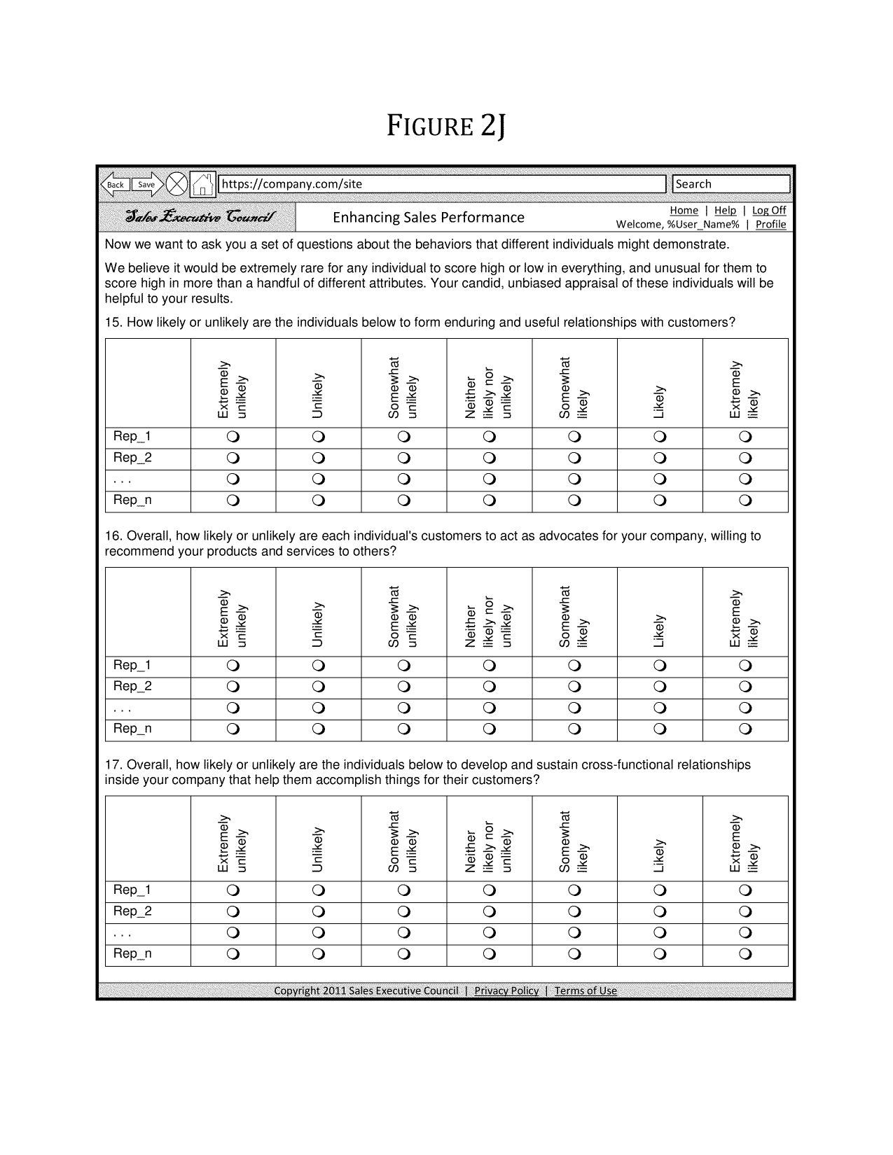

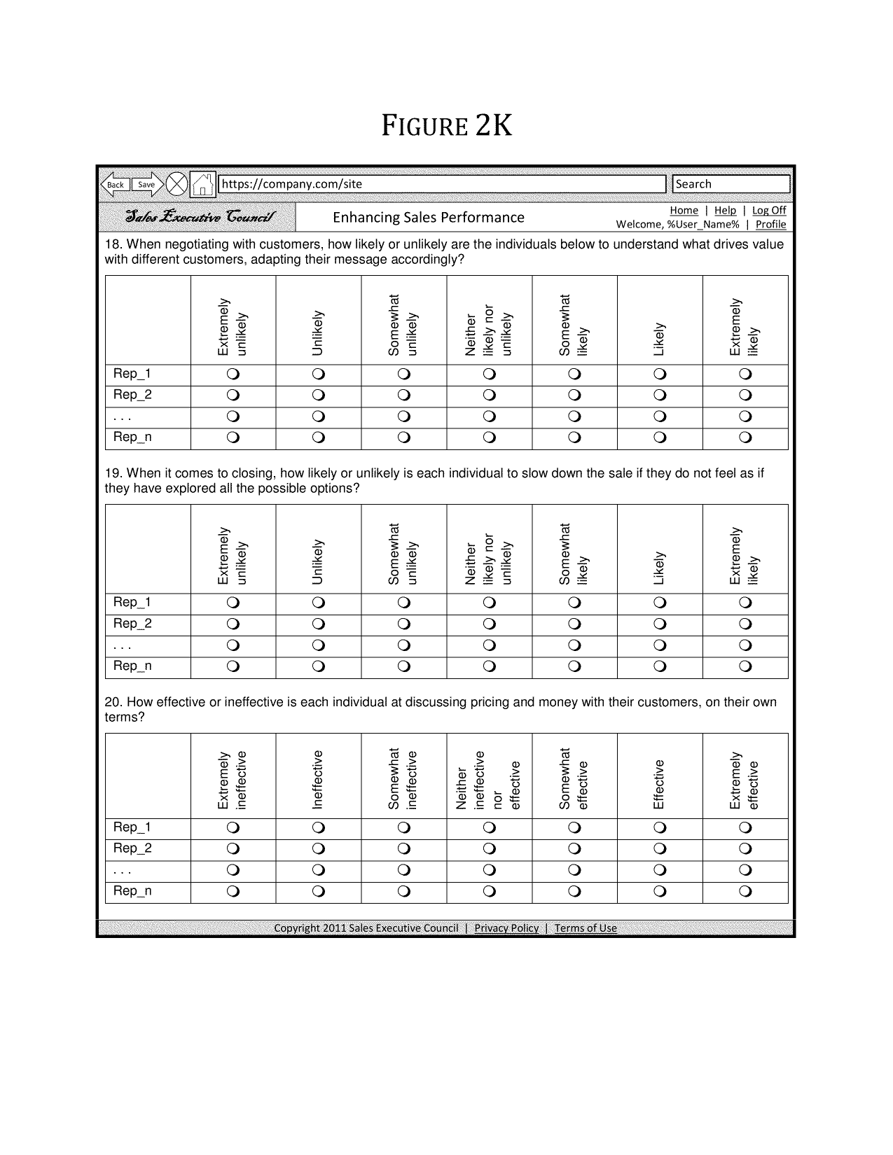

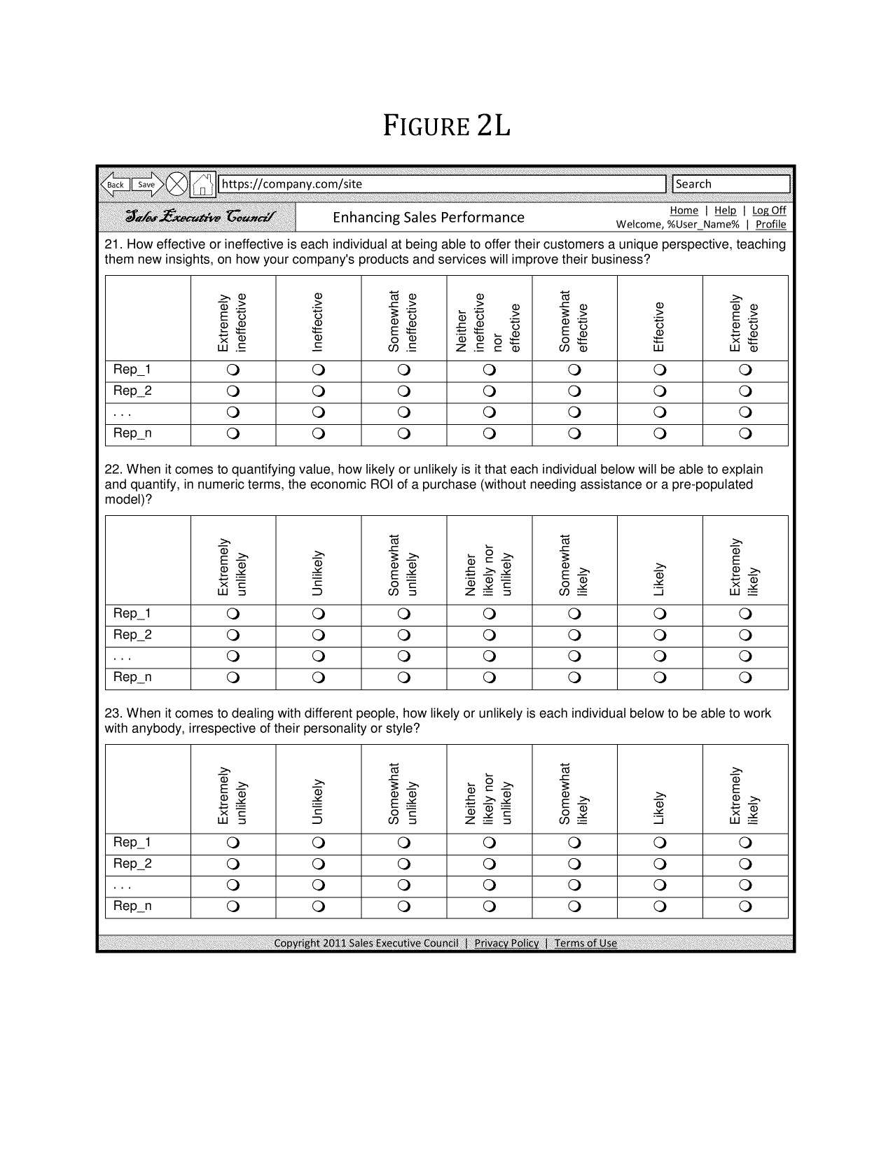

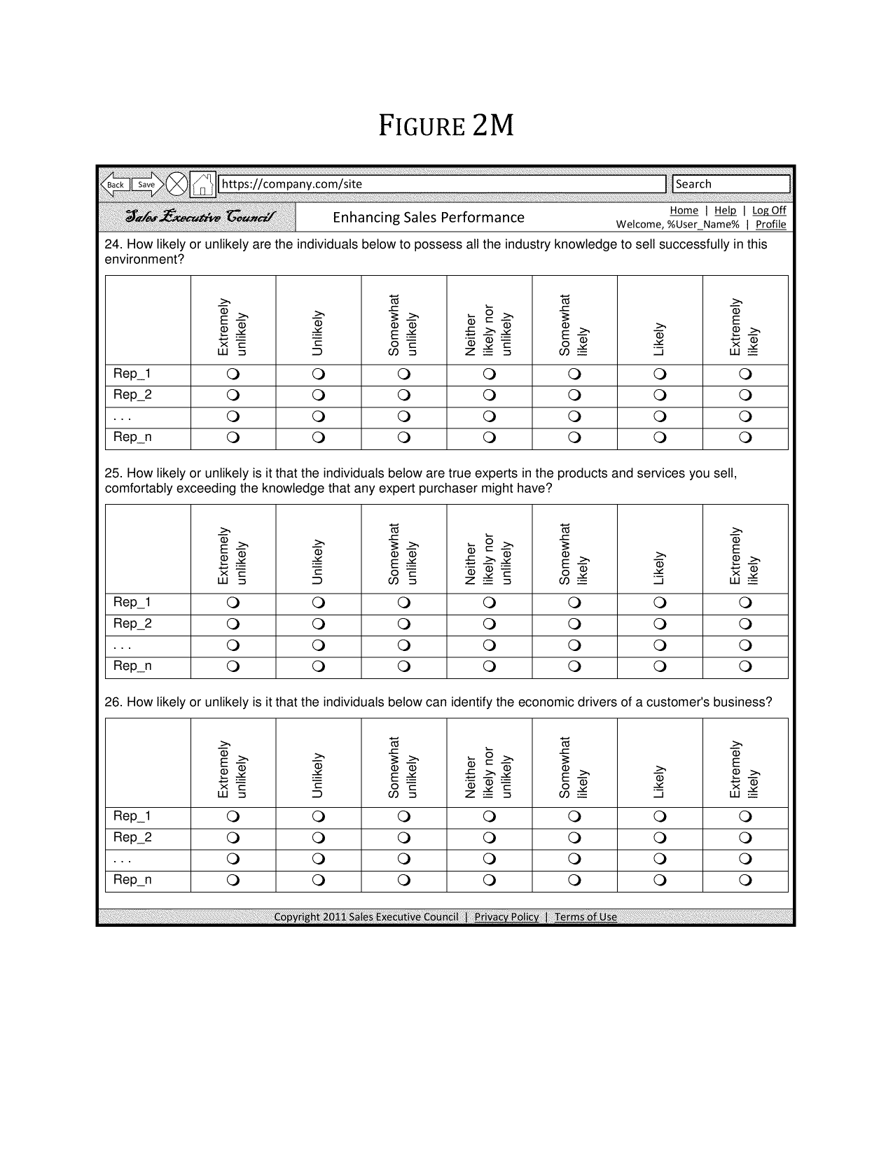

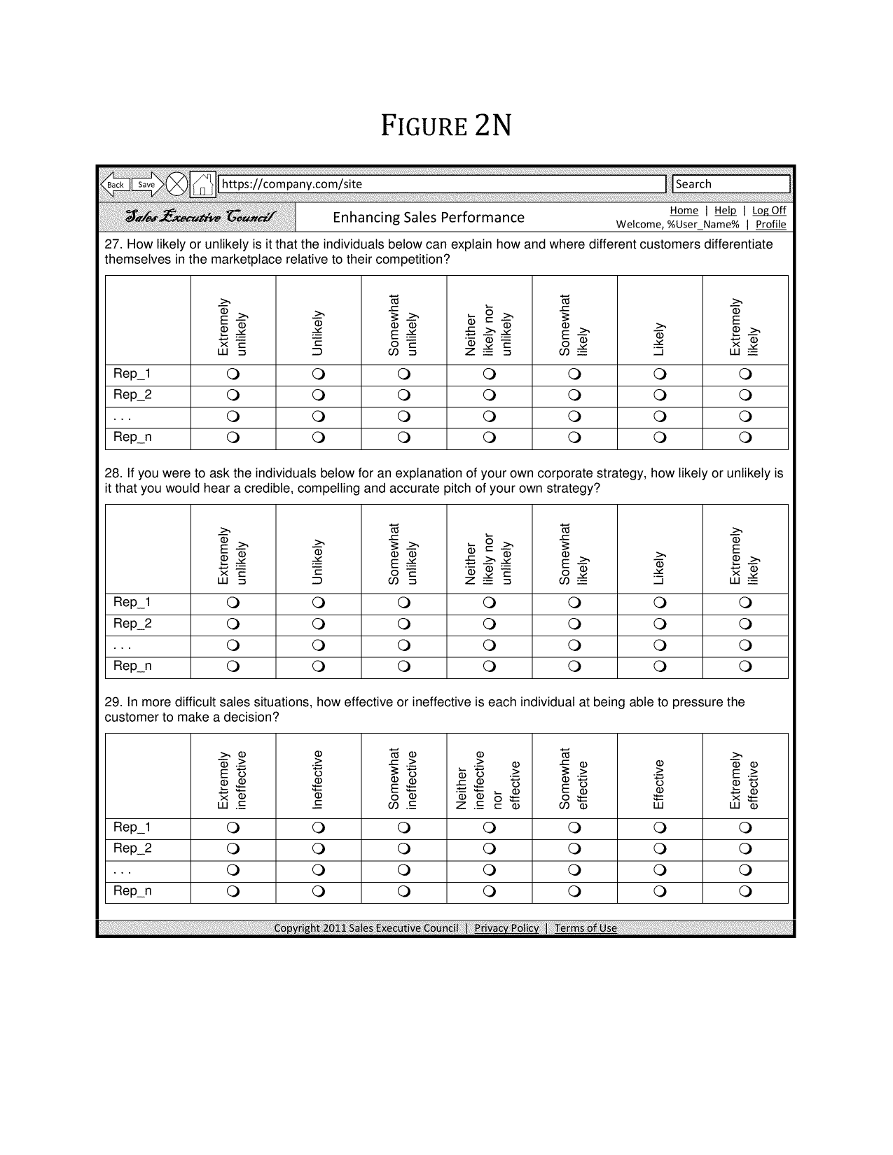

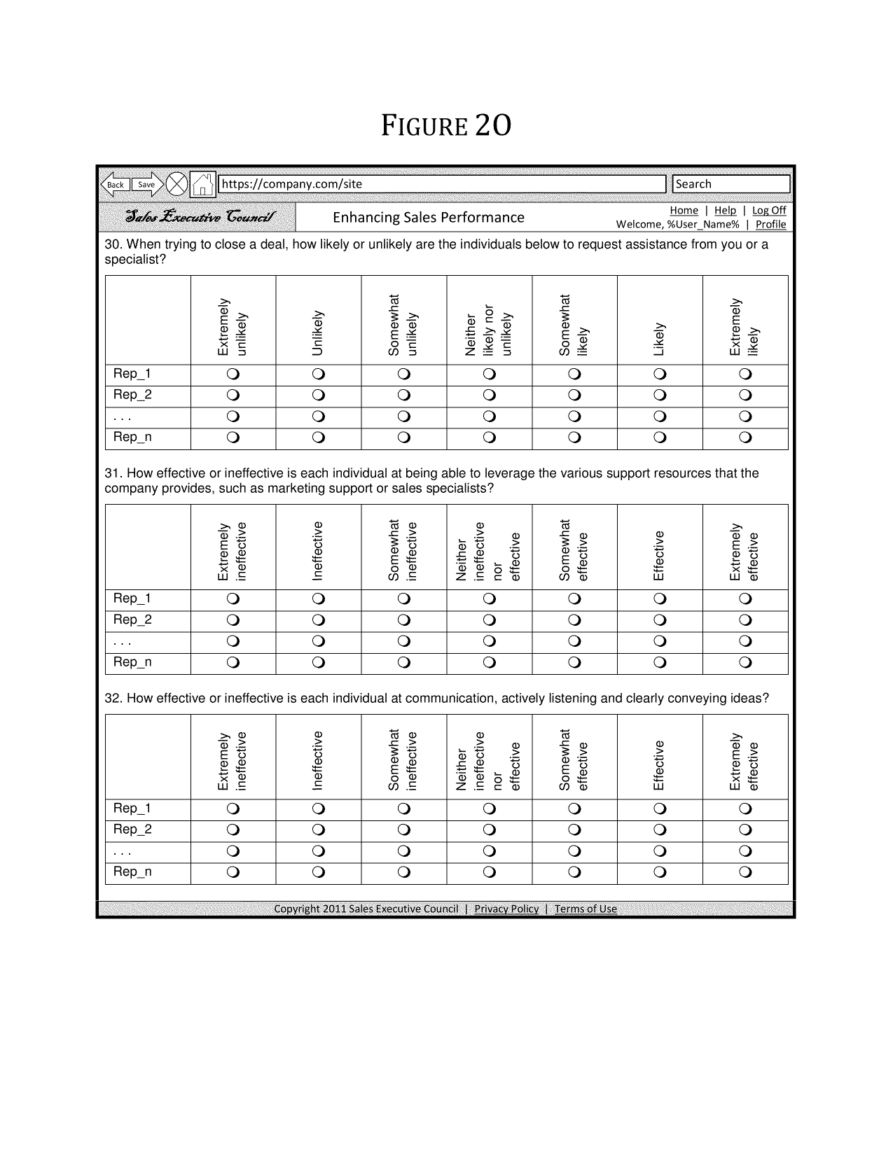

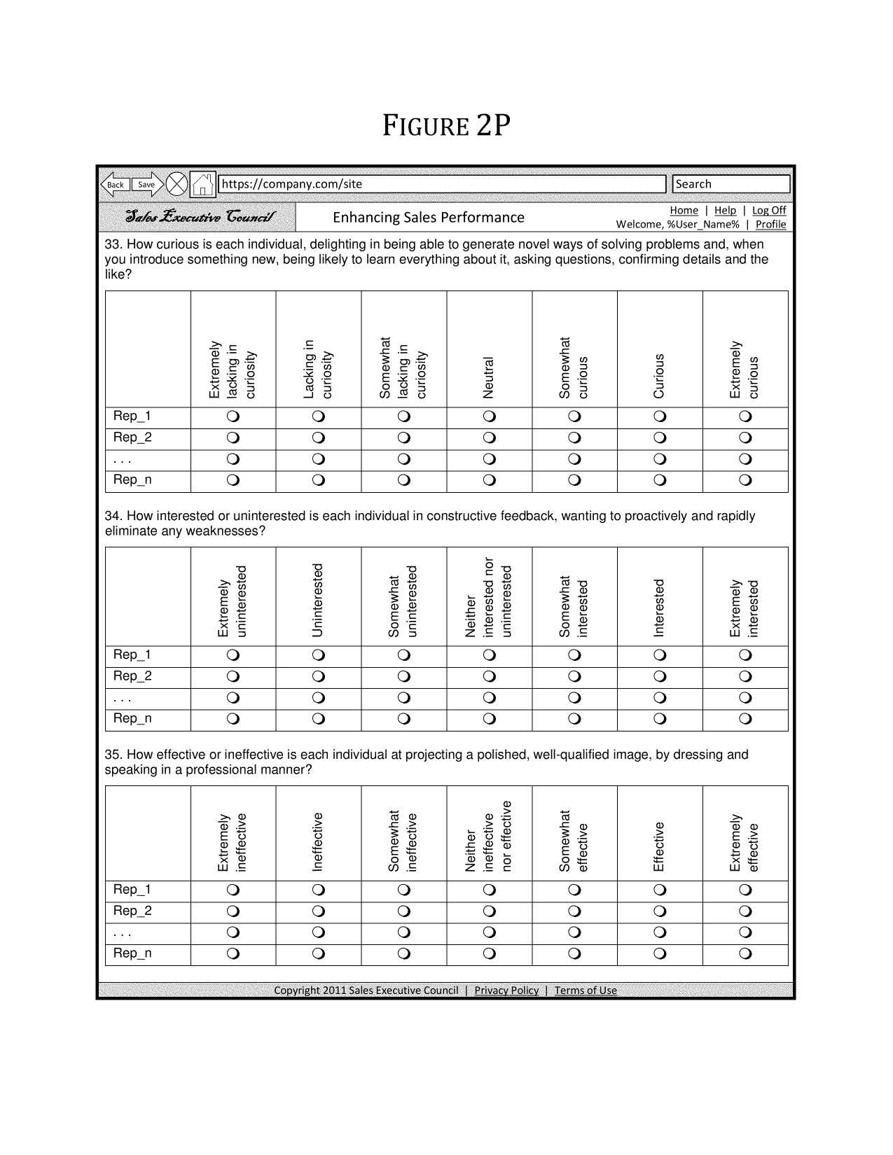

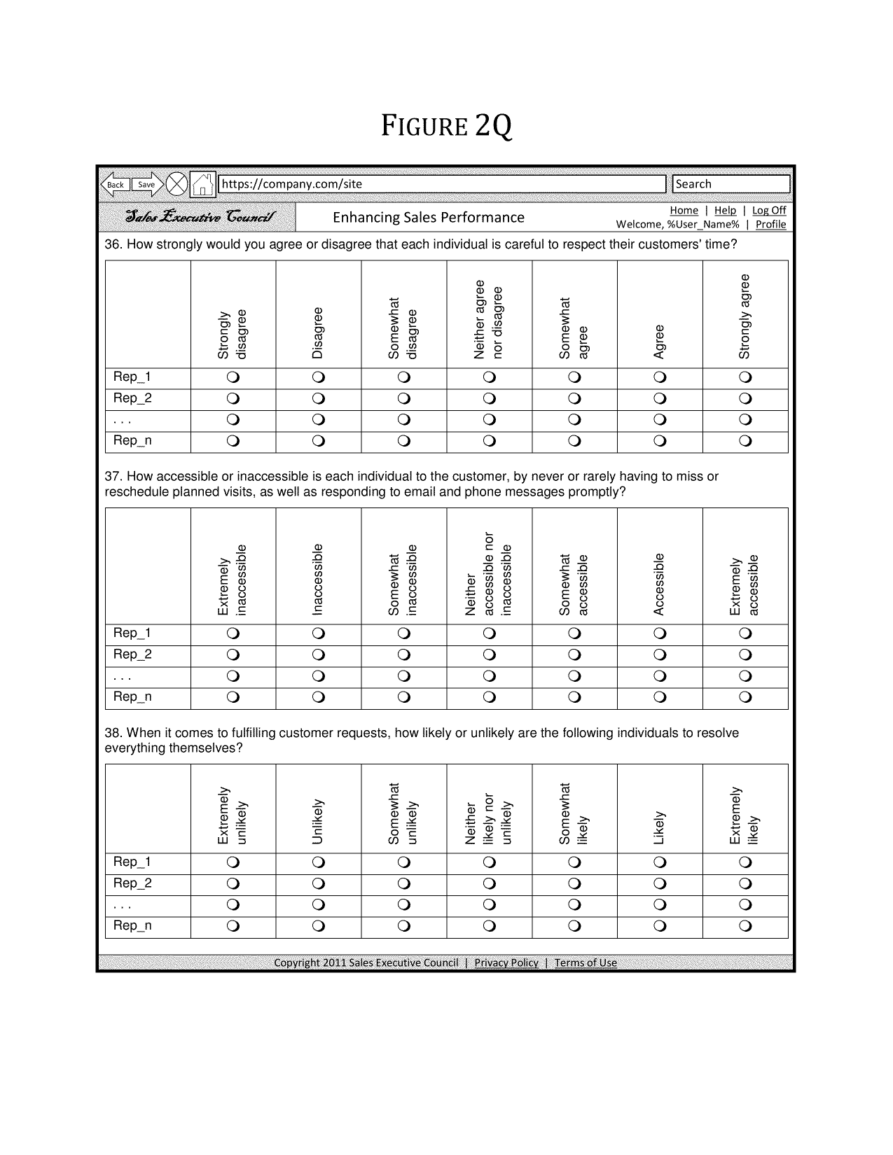

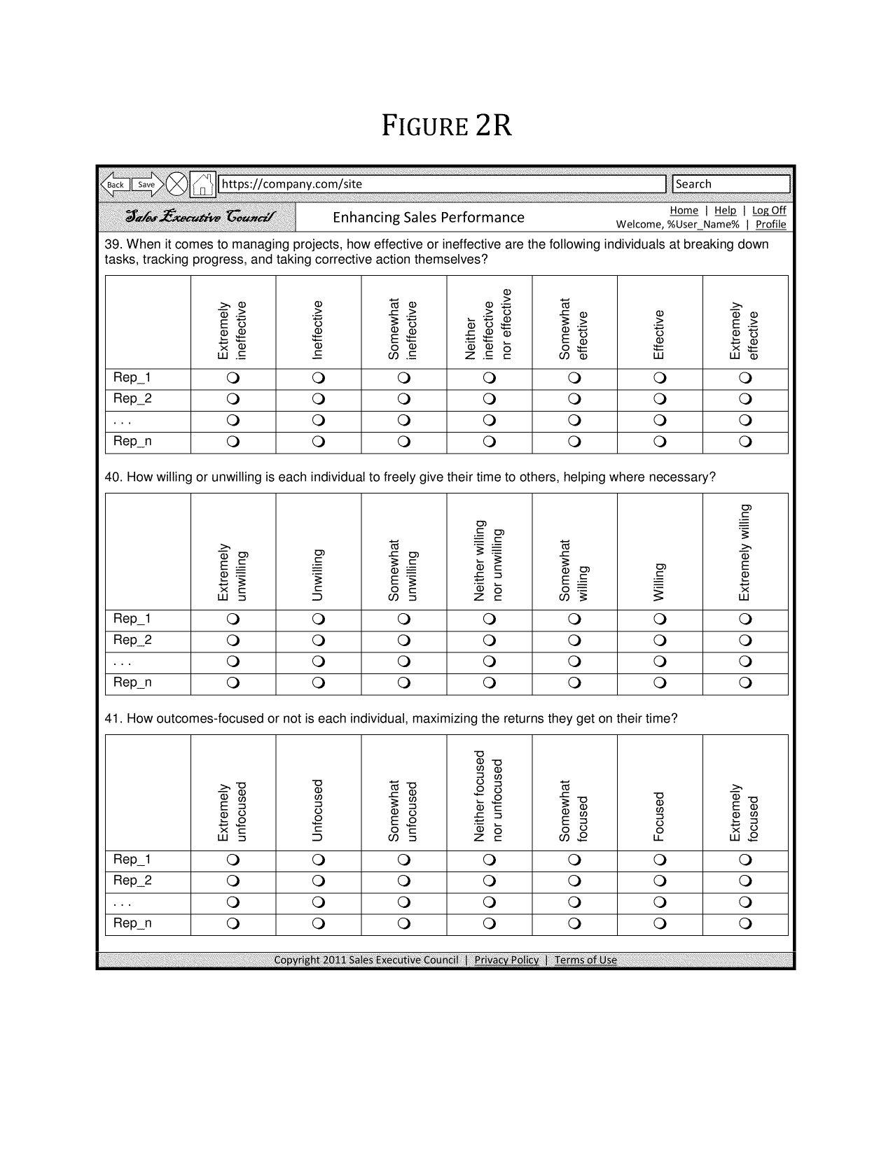

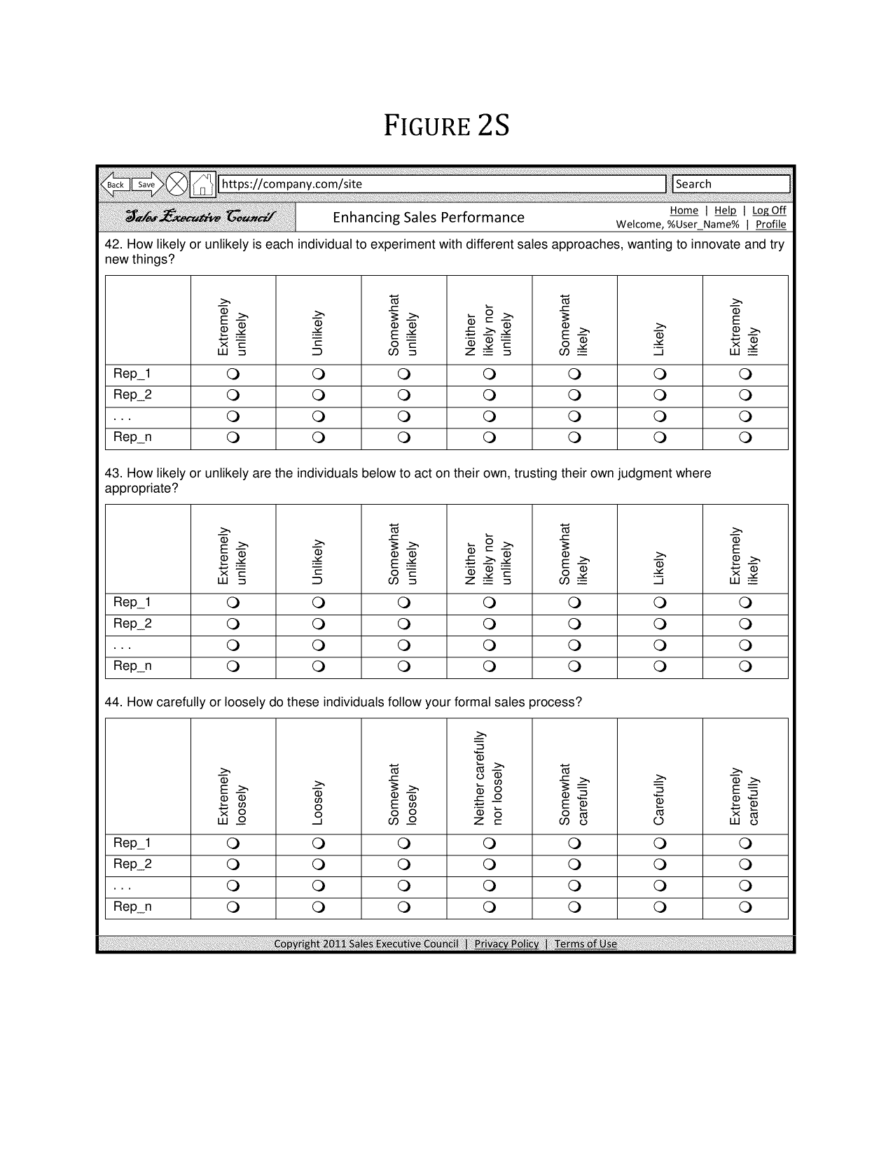

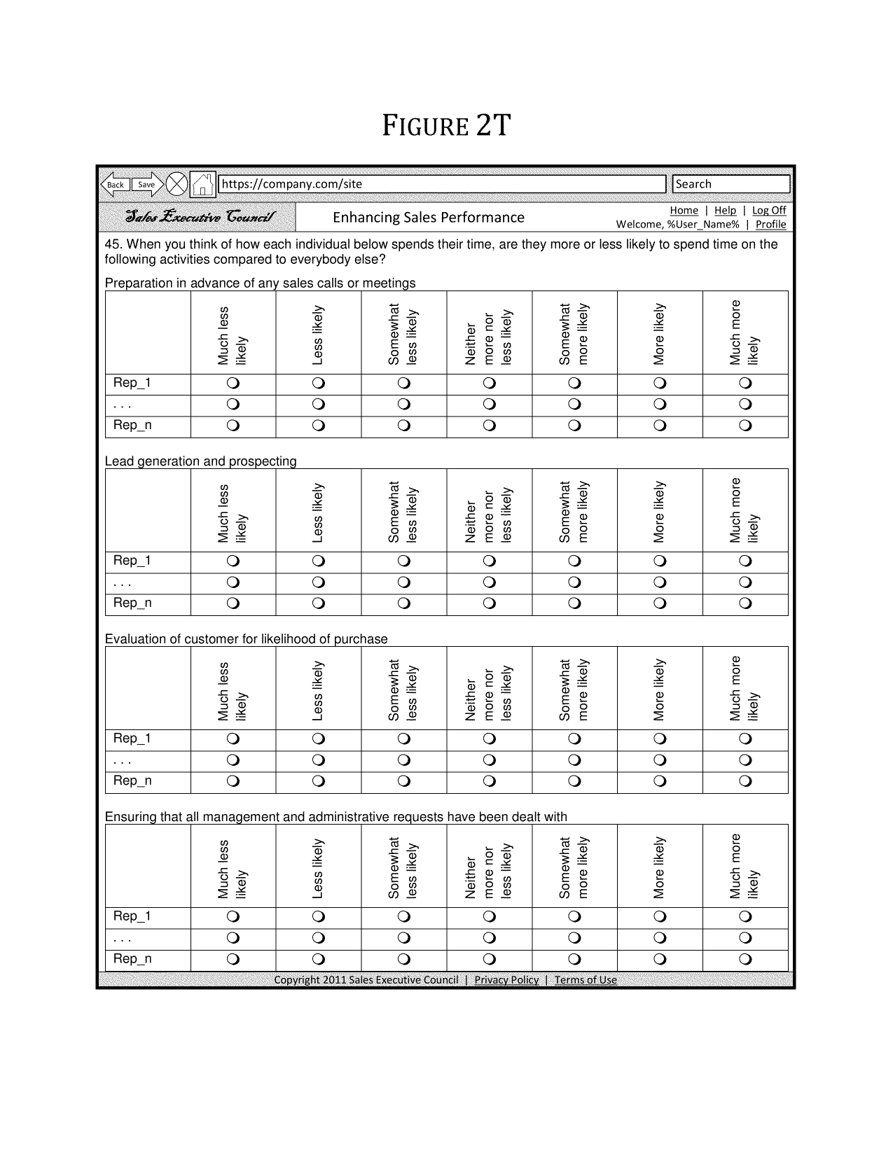

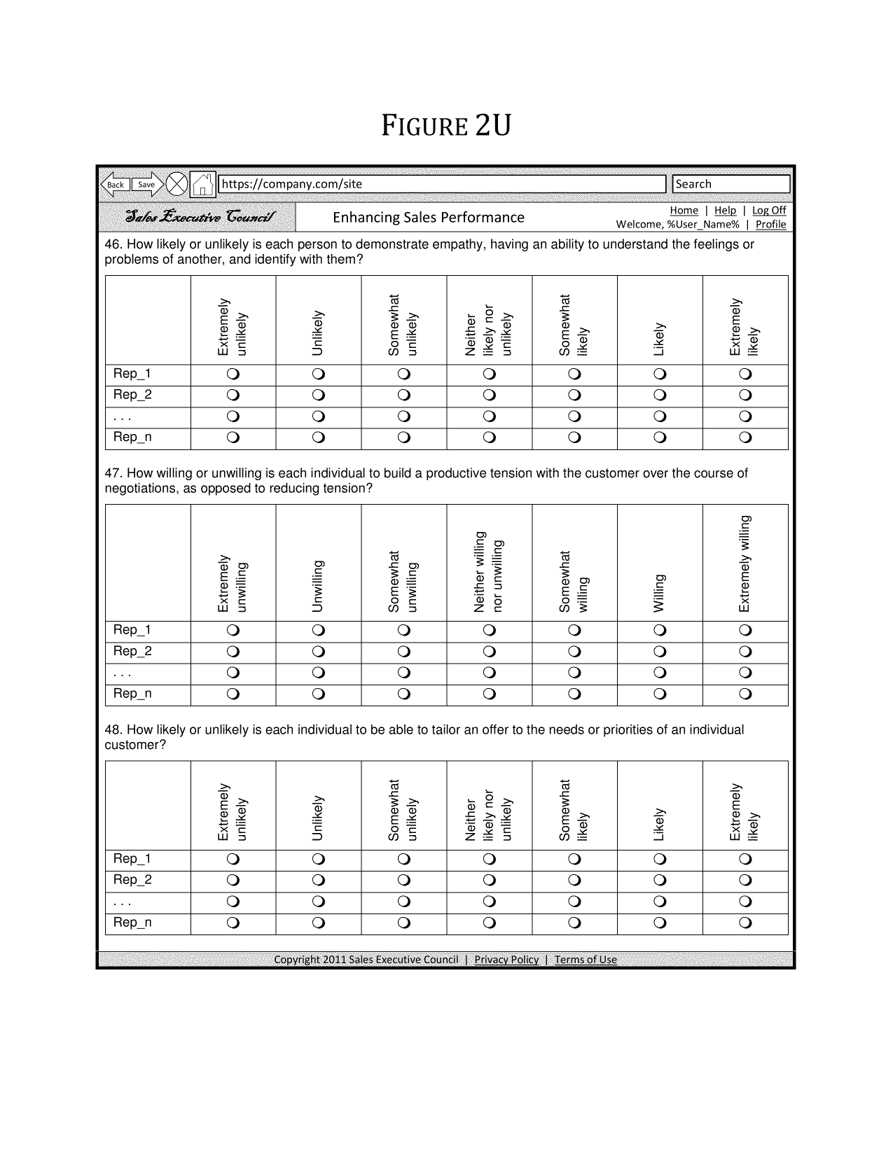

The application will collect, by way of user input (see generally, FIGS. 2B-2D), and usually store in a computer file, some project-specific information, such as project-specific identifications and project boundaries and scope, or else retrieve previously stored project specific information from a computer file in order to associate project specific information and the data generated by such project. Preferably, on accessing the system for the first time for a new project, a unique project identification will be generated, either by the computer application assigning a unique identification code, or the code is generated by the user, and checked against existing codes for uniqueness, or a combination of these techniques and other known or newly developed techniques for associating user inputted information with application generated data may be used.

Additionally, the application will collect, by way of user input, and usually store in a computer file, information specific to the industry or market the company serves. This information might include items such as the sales cycle time, the average order size or the number of people involved in the purchase. The goal is to understand the relative complexity of the sales roles and to ensure the application of the appropriate sales culture construct. Typically individual survey respondents are also asked these questions to determine whether or not there are any significant differences in terms of how management and individuals conceive of the selling roles.

Also typically occurring at the start of a new project, the system will receive computerized input of information and the parameters of the application adjusted in order to customize the performance of the application and processing of information, and the generation and reporting of data from the system. For example, the number of sales professionals to be assessed, the particular questions to be used, the industry comparison benchmarking, and such other information as will optimize the generated computers reports once the project data is analyzed.

As shown in FIG. 1A, the application receives the reporting structure and sales professional performance data 115 for the business and sales reps to be assessed. Typically, sales or profit attainment numbers are associated with each sales rep to be assessed. This generally occurs at the time a new project is begun, but optionally can occur at any time prior to analysis of project data, and can even be omitted. Preferentially, the business's data can be provided in an XML file generated from its own internal computers. Alternatively, the user can use a computer to input such information, for instance in an application generated survey (see generally, FIGS. 2C-2D).

Next as shown, the application generates computerized input forms for conducting a survey comparing the sales professionals to be assessed 120. Advantageously, sales managers (or other individuals with knowledge of the individual sales professional's work) assess their direct reports and others using a computerized online assessment. Optionally, the survey may be via a known commercially available survey system (surveymonkey.com and others are known). Another option is for the survey to be conducted freehand with pen and paper, or following a predetermined template or form and the data collected is thereafter coded into a data structure for input into the application, for example by an XML input statement.

The assessment survey consists of a number of demographic questions and different statements calling for a rating and describing aspects of how an individual may or may not go about the function of selling. In a preferred embodiment, there are, for example, somewhere between 40 and 50 of these questions and statements. FIGS. 2A-2U show a representative survey with various questions and statements. The survey is typically designed to clarify the difference between skill and attitudinal differences of high and core performers.

The assessment forces a relative comparison between different sales professionals by asking the respondent to simultaneously assess different sales reps along a uniform scale (typically, 5 or 7 approximately equal gradations, such as “Extremely negative,” “Negative,” “Somewhat negative,” Neither positive nor negative,” “Somewhat positive,” “Positive,” and “Extremely positive” where “negative” and “positive” can be replaced with any other polar opposites defining a characteristic, such as “unlikely” and “likely,” “inefficient” and “efficient,” and “unfocused” and “focused”—other examples of between 5 and 9 gradations are shown in FIGS. 2E-2U) instead of asking respondents to assess sales reps sequentially. This results in the respondent providing a somewhat normalized assessment because the aggregated result for all sales reps is shown at once and the respondent will be better able to rate each one viz a viz the others.

The online assessment, or survey software, is optionally programmed to show one question at a time (or only a few specifically related questions), showing each individual's name underneath the question and establishing a uniform scale for recording responses.

The survey will advantageously probe differences among sales rep in one of more of the categories set forth in TABLE 1:

TABLE 1
DEFINITIONS

Key Sales Skills:
In more difficult sales situations, how effective or ineffective is each individual at being able to pressure
the customer to make a decision?
How likely or unlikely is it that the individuals below can identify the economic drivers of a customer's
business?
How effective or ineffective is each individual at being able to offer their customers a unique perspective,
teaching them new insights, on how your company's products and services will improve their business?
How effective or ineffective is each individual at discussing pricing and money with their customers, on
their own terms?
When negotiating with customers, how likely or unlikely are the individuals below to understand what
drives value with different customers, adapting their message accordingly?
How effective or ineffective is each individual at communication, actively listening and clearly conveying
ideas?
When it comes to managing projects, how effective or ineffective are the following individuals at breaking
down tasks, tracking progress, and taking corrective action themselves?
When it comes to quantifying value, how likely or unlikely is it that each individual below will be able to
explain and quantify, in numeric terms, the economic ROI of a purchase (without needing assistance or a
pre-populated model)?
When trying to close a deal, how likely or unlikely are the individuals below to request assistance from
you or a specialist?
Overall, how likely or unlikely are each individual's customers to act as advocates for your company,
willing to recommend your products and services to others?
If you were to ask the individuals below for an explanation of your own corporate strategy, how likely or
unlikely is it that you would hear a credible, compelling and accurate pitch of your own strategy?
How likely or unlikely is it that the individuals below can explain how and where different customers
differentiate themselves in the marketplace relative to their competition?
How likely or unlikely is each individual to experiment with different sales approaches, wanting to
innovate and try new things?
Entrepreneurial Behaviors:
How likely or unlikely are the individuals below to act on their own, trusting their own judgment where
appropriate?
When it comes to fulfilling customer requests, how likely or unlikely are the following individuals to
resolve everything themselves?
When it comes to closing, how likely or unlikely is each individual to slow down the sale if they do not feel
as if they have explored all the possible options?
How likely or unlikely are the individuals below to form enduring and useful relationships with customers?
Effort Attitudes:
How outcomes-focused or not is each individual, maximizing the returns they get on their time?
How motivated or unmotivated is each individual to work primarily toward goals, promotions, prestige, or
incentives?
How likely or unlikely are the following individuals to demonstrate tenacity, to persevere in spite of
obstacles, or “stick to their guns” in spite of criticism?
How likely or unlikely are the following individuals to put discretionary effort into their work, always be
willing to go the extra mile, or look for ways to be better at their job?
How curious is each individual, delighting in being able to generate novel ways of solving problems and,
when you introduce something new, being likely to learn everything about it, asking questions, confirming
details and the like?
How interested or uninterested is each individual in constructive feedback, wanting to proactively and
rapidly eliminate any weaknesses?
How strongly or weakly is each individual attached to the company, by their enthusiasm for what the
company does and their belief in its value?
Proces
When you think of how each individual below spends their time, are they more or less likely to spend time
on the following activities compared to everybody else?
Preparation in advance of any sales calls or meetings
Lead generation and prospecting
Evaluation of customer for likelihood of purchase
Ensuring that all management and administrative requests have been dealt with
How carefully or loosely do these individuals follow your formal sales process?
Knowledge:
How likely or unlikely are the individuals below to possess all the industry knowledge to sell successfully in
this environment?
How likely or unlikely is it that the individuals below are true experts in the products and services you sell,
comfortably exceeding the knowledge that any expert purchaser might have?
Internal Savvy:
How effective or ineffective is each individual at being able to leverage the various support resources that
the company provides, such as marketing support or sales specialists?
Overall, how likely or unlikely are the individuals below to develop and sustain cross-functional
relationships inside your company that help them accomplish things for their customers?
Professionalism:
How effective or ineffective is each individual at projecting a polished, well-qualified image, by dressing
and speaking in a professional manner?
How accessible or inaccessible is each individual to the customer, by never or rarely having to miss or
reschedule planned visits, as well as responding to email and phone messages promptly?
When it comes to dealing with different people, how likely or unlikely is each individual below to be able
to work with anybody, irrespective of their personality or style?
How strongly would you agree or disagree that each individual is careful to respect their customers' time?
How willing or unwilling is each individual to freely give their time to others, helping where necessary?
Selling Approach:
Please rate the effectiveness of each individual at creating territory plans at account level (using existing
planning tools and processes) that are built back from the Nixon Medical product plans and customer
account segmentation.
When approaching customer account segmentation, how likely or unlikely are the individuals below to
use their understanding of customer needs to develop a truly customer focused product and service value
proposition?
When it comes to rep productivity, how likely or unlikely is each individual to prioritize and focus on the
highest value sales opportunities within their target accounts?
How likely or unlikely is each individual to modify or change their sales approach to incorporate the
coaching suggestions that you give them?
Risk Taking Attitudes:
How willing or unwilling is each individual to risk disapproval in order to express beliefs about what is
right for the customer?
Would you say each individual is more introverted, being modest and thoughtful, or more extroverted,
being assertive and affable?

As can be readily appreciated by those in the art, the statements build on prior work by combining aspects of the underlying constructs being measured by known assessment instruments such as Big Five, as well as existing information around Competency Clusters as defined by Spencer, McClelland and Spencer: “Achievement, Helping/Service, Influence, Managerial, Cognitive and Personal Effectiveness” which disclosure is hereby incorporated by reference. For example, statements around “Giving time to help others” (see, e.g., Question 40, FIG. 2R), “Respecting the customer's time” (see, e.g., Question 36, FIG. 2Q), “Being able to work well with others” (see, e.g., Question 23, FIG. 2L) were explicitly designed to proxy the agreeableness dimension of Big Five and the Helping/Service dimensions of the Competency Cluster model. Attributes around “Being motivated by goals” (see, e.g., Question 12, FIG. 2H), “Willingness to expend discretionary effort” (see, e.g., Question 9, FIG. 2G) and “tenacity” (see, e.g., Question 10, FIG. 2H) were designed to account for the Conscientiousness dimension of Big Five and the “Achievement Orientation” competency cluster. Other attributes were designed to address the knowledge dimension necessary to perform any work.

Most remaining attributes were designed to address the harder aspects of selling such as effectiveness at “offering customers a unique perspective on how your company's products and services will improve their business” (see, e.g., Question 21 FIG. 2L) or likelihood of being able to “explain how and where different customers differentiate themselves in the marketplace” (see, e.g., Question 27 FIG. 2N).

The last few questions then concern aspects of how different sales reps prioritize their time. These questions are based on prior Sales Executive Council research showing how high-performing sales reps emphasize “preparation in advance of a call”, “lead generation”, “the qualification of different customers for likelihood to purchase” and “the fulfillment of administrative duties” (this last one known to negatively correlate with high sales performance) (see, e.g., Question 45 FIG. 2T).

At the end of the survey, the application generates, for each assessed sales rep from among the plurality of sales reps to be assessed, a computerized assessed sales rep record for each said assessed sales rep comprising a plurality of individual dimension scores, each said individual dimension score representing an assessment of said assessed sales rep along the associated dimension. This record is stored in the database using the pre-determined record data structure. By comparison with the known high performing sales reps, this allows a determination of the degree of improvement possible based on improvements seen within the database.

Next as shown, the application determines which profile type from the underlying construct the sales rep record matches using the database 125, and preferentially, industry comparison benchmarking data from the database. A variety of analytical techniques are used to categorize individual sales reps into uniform profile types. Most generally, computerized methods are used to compare each assessed sales rep record to the predetermined sales rep records in the database to determine whether any individual dimension scores for the assessed sales rep record meet or exceed a predetermined value along the associated dimension for that value indicative of a high performing sales rep. For example, a plurality of derived combination dimensions can be included in the record that measure that sales rep along arbitrary dimensional scales representing different sales rep types modeled by the construct.

In addition, the composition of the entire sales force is compared to a global benchmark or preferably to industry comparison benchmark, allowing the company to characterize the dominant sales culture of the entire sales force from among the sales culture types defined by the construct. Subsequently, individual sales rep performance data is used to identify company-specific differences in terms of high performing sales reps relative to their less successful peers.

At the end of the assessment, and as a result of the profile determination, individuals are typically assigned to different sales culture types based on their relative strengths and weaknesses. The assignment is based on a factor analysis of a large benchmark sample that has succeeded in deriving underlying competencies that predict sales success in different environments.

In preferred embodiments of the invention, the sales culture types match a model construct having the five profile types as shown in TABLE 2:

TABLE 2
CHALLENGER MODEL

THE CHALLENGER - Always has a different view of the world. Understands the customer's
business. Loves to debate. Pushes the customer. Research by the inventors herein have found
this to be the most successful sales culture type across industries. Additionally, the research
has shown that focusing on developing the Challenger type will lead to improved sales rep
performance in more complex sales environments (longer sales cycles (more than 3 months),
significant negotiation and tailoring involved, and multiple buyers involved).
THE LONE WOLF - Follows own instincts. Self-assured. Difficult to control. The research shows
that this type may have advantages in small, starting up companies, but is less successful as
those companies grow and mature.
THE HARD WORKER - Always willing to go the extra mile. Doesn't give up easily. Self-
motivated. Interested in feedback and development. The research shows that developing the
Hard Worker profile will lead to improved sales rep performance in more transactional sales
environments (short cycles, little to no negotiation involved and no more than 2 buyers
involved).
THE PROBLEM SOLVER - reliably responds to internal and external stakeholders. Ensures that
all problems are solved. Detail oriented.
THE RELATIONSHIP BUILDER - Builds strong advocates in customer organization. Generous in
giving time to help others. Gets along with everyone. The research shows that over
development of this type will lead to relative underperformance.

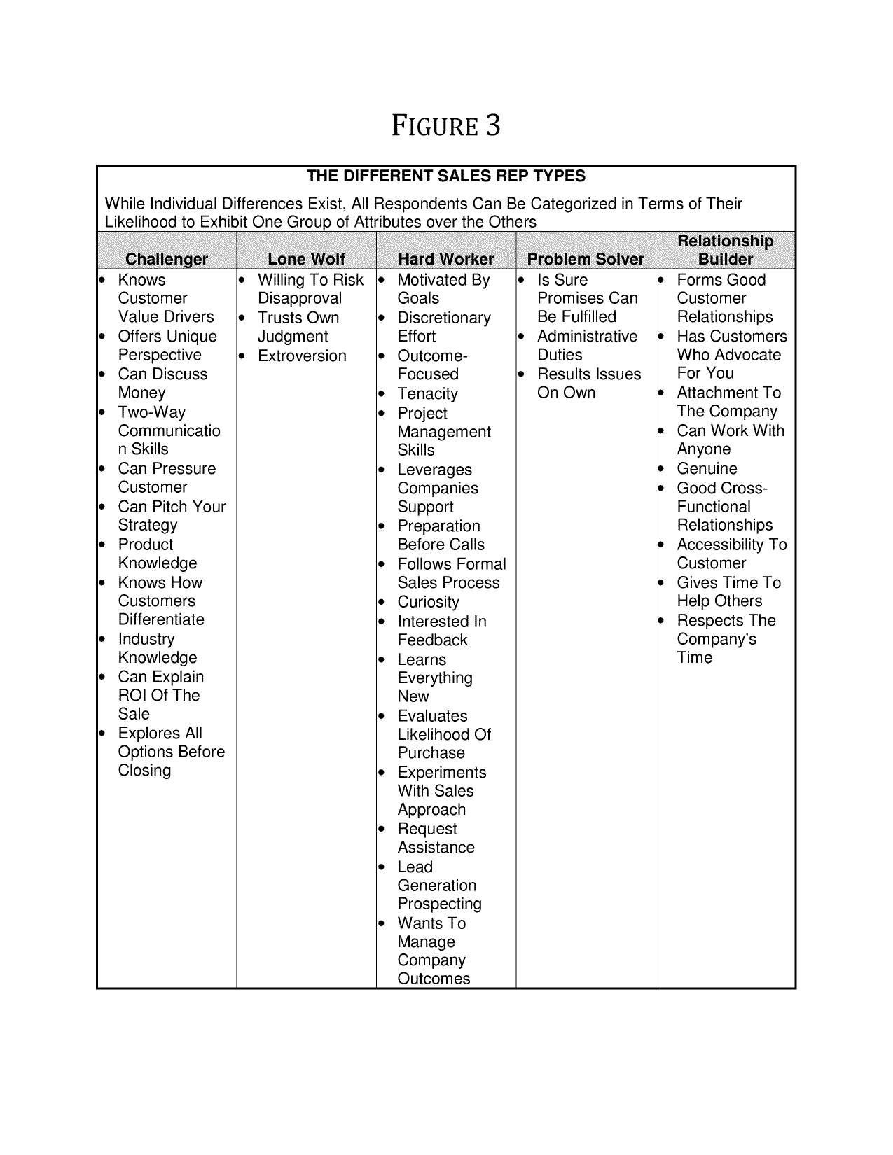

FIG. 3 shows selected details about the different sales rep profile types. In general, constructs will define several, usually more or less mutually exclusive, profile types providing an insight into factors explaining sales performance, and more particularly, those factors associated with high performance within the particular sales culture.

The profile types are determined using a factor analysis (principal components analysis) to identify common groups of characteristics. While every person may have some characteristics from each sales profile type, each sales rep will generally have one predominant profile type.

In a preferred embodiment of the invention, factor analysis (specifically, principal components using Varimax rotation) identifies the 5 factors underlying the questions being asked. More details regarding this techniques are provided later herein.

The Challenger factor is primarily described in terms of scoring higher across questions around: Offering a unique perspective, having 2 way communications skills, knowing customer value drivers, ability to identify economic drivers, comfort with discussing money and ability to pressure the customer. One benefit of the systems and methods described is being able to quantify not just that each of these skills has independent, predictive value but being able to establish that individuals possessing the combination of these discreet skills will be much more likely to succeed as sales people. More specifically, the systems and methods herein link some of these skills to specific interventions:
Offering a unique perspective and being able to communicate are about being able to articulate to the customer why a supplier, uniquely, is able to deliver services the customer cares about in a way that is different from the competition. This is about positioning the company's value proposition and it is found that companies where entire groups score below the benchmark typically need extra marketing support to close these gaps.
Knowing customer value drivers and ability to identify economic drivers are about relating the supplier's offer to the customer's precise needs. Groups of individuals scoring below the benchmark on these attributes typically benefit from training in business acumen and in having them document the things that different kinds of buyers (levels and industries) might make use of the supplier's products and services.
Groups scoring below average on Comfort with discussing money and ability to pressure the customer benefit from being trained in negotiation tactics and might assistance helping them develop the resilience required to work through more complex, multi-party negotiations.

The Lone Wolf factor is described in terms of willingness to risk disapproval, trusting own judgment, and extroversion. Analysis finds that this smaller group of individuals represents a disproportionate number of high performers. Companies where there are disproportionate number of Lone Wolfs are typically found to possess weak management. The systems and methods described typically provide an indication to companies on how to understand how management is regarded.

The Hard Worker factor is described in terms of being motivated by goals, demonstrating discretionary effort, being outcomes-focused, being tenacious. It is found that this is an appropriate profile for less complex sales organizations (defined as one where the sales cycle is shorter than 90 days and where individuals do not manage more than 60 accounts). When groups score below the benchmark at less complex organizations, the systems and methods described present results enabling companies to first look to their hiring practices (especially since less complex sales environments tend to show higher levels of churn) and to then look at the incentive practices to see if there are any reasons for incumbents to demonstrate less discretionary effort.

The Problem Solver is the sales rep who wants to be absolutely certain that promises can be fulfilled, that they perform the right administrative duties and resolve issues on their own. Analysis finds that this is a more appropriate profile for a customer service professional and the systems and methods described provide results advising companies where there are larger number of these individuals to think carefully about whether or not these individuals are in the right role.

The Relationship Builder is then the sales rep who scores higher on forming good customer relationships, having customers who advocate for them, and who is attached to the [supplier] company. These individuals generally score high on agreeableness but lack the skills that differentiate the most successful sellers (in an absolute sense, individuals typically score high at these skills and they can be said to be easier skills to exhibit). Analysis finds that these individuals are less likely to be able to have the kinds of discussions that move customers toward making changes at their organization.

In addition to the profile types for individual sales reps, a comparison between high and core performers as a group can be performed and thus reveal any gaps that might explain additional differences that will be important for different businesses.

Turning back to FIG. 1A, since the method is most advantageously performed on more than one sales rep, the application will iteratively, for each sales rep in the survey 130 determine whether an individual sales rep has any strengths 135. While most people will have positive scores on at least one of the dimensions assessed, a smaller number of respondents will only have negative scores. Scores of these sales reps are not included in the database of records (they might said to fall into a 6th profile; that of lacking sales ability). The record scores are then matched with the objective sales performance numbers and if the determination 135 is positive, the sales rep record in the database will have an appropriate high performance indicator 140.

In either case after the determination 135, the application determines an action plan for the sales rep 145, which will generally be in the form of matching up the sales rep record against a set of standard sales rep profile type information to select a predetermined course of study or training which has been selected, most typically, based on what has worked in the past for particular sales rep profile types matching the sales rep record under analysis and designating same as the action plan. In a typical result, Challenger types—which the research indicates is often the most successful type over many sales cultures—can receive Challenger-enhancing training and guidance, shown to be effective in enhancing Challenger-type sales performance.

The application will then determine if there is another rep to analyze 150, and if so, for the next rep in the survey 155, the application will go back to the step at 130 and continue with the next sales rep.

When there are no longer any unanalyzed sales rep records 150, the application then aggregates and provides the results 160 before coming to a stop 170. Typically, computerized reports are generated including one or more indicators of specific dimensions for each, or a group of assessed sales reps, where those dimensions represent particular categories (dimensions) which by incremental improvement in the associated dimension score will improve the alignment (match) of the sales rep record with one or more high-performing sales rep records. Additionally, reports will generally contain one or more indicators of a predetermined course of action to be followed in order to effect the incremental improvement of the assessed sales rep in the associated dimension scores.

Of course, the application will advantageously allow the user to interact with the provided aggregated results by adjusting parameters, reviewing individual data (including individual sales rep records), and generally using the application to focus in on particular characteristics disclosed in the aggregated and individual results.

Action Plans

The following tables outline specific skills that can be focused on for improvement to better align a sales rep of a given profile type to that of a sales rep of the Challenger profile type.

Challenger Action Plan for Lone Wolves

Lone Wolves skills and attributes include:
Willing to Express Beliefs/Opinions
Extroverted
Tenacious
Acting on Their Own
To better align Lone Wolf behavior with that of the Challenger type,
the following skills warrant closest attention:
Explain & Quantify the ROI (return on investment) of a Purchase
Follow Formal Sales Process
Tips/Tactics
Consistently employ pre-call planning checklists and tools.
Rehearse teaching pitch ahead of the customer meeting and ensure
messaging is consistent with your organization's direction
Provide an overview of the customer's goals and objectives and for
proof that these are in fact the customer's primary goals/objectives.
Work with all key stakeholders within the customer organization.
Take control of the sales process and apply pressure to customers
appropriately.
Tie agreed-upon next steps to the next phase of your sales process.

Challenger Action Plan for Hard Workers

Hard Workers skills and attributes include:
Gives Discretionary Effort
Motivated
Outcomes Focused
Opportunity Generation
To better align hard Worker behavior with that of the Challenger type,
the following skills warrant closest attention:
Explain How Customers Differentiate Themselves
Product Knowledge
Tips/Tactics
Strive to study and learn about new products or industry trends each
week.
Target specific information and data about each product or trend that
re most relevant to prospects and customers.
Create a check list of relevant items to know for the primary roles of
your customer contacts.
Strive to take a targeted approach to uncover key information.
Aim to end every sales call/meeting with a confirmed and agreed upon
next step for each client.
Incorporate “triggers” or things to look/listen for in the sales
process to consider when challenging customer objections.

Challenger Action Plan for Problem Solvers

Problem Solvers skills and attributes include:
Explore All Options
Follow Sales Process
Project Management
Administrative Activities
To better align Problem Solver behavior with that of the Challenger type,
the following skills warrant closest attention:
Identify Customer Economic Drivers
Industry Knowledge
Tips/Tactics
Leverage problem solving skills to identify customer pain points (known
or unknown) in advance of sales calls that your company can help solve.
Keep a list of key facts to learn and know about each customer.
Strategically put yourself in the customer's shoes (i.e., How do our key
contacts get rewarded for success against business objectives? How do
we know this pain point is of critical importance to this company?).
Role play the opportunity costs for not addressing the pain points;
determine how to quantify the risk for customers if they do not act..

Challenger Action Plan for Relationship Builder

Relationship Builders skills and attributes include:
Forms Enduring Relationships
Attachment to Their Own Company
Can Work With Anyone
Respects Customer's Time
To better align Relationship Builder behavior with that of the Challenger
type, the following skills warrant closest attention:
Discuss Pricing & Money
Pressure the Customer to Make a Decision
Tips/Tactics
Maintain focus on the personal and business objectives of their
customers.
Practice your teaching pitch ahead of the customer meeting.
Maintain a check list of questions that you should be able to answer
about a customer contact.
Ensure that sales reps are taking a targeted approach to uncover key
information.
Aim to end every sales call/meeting with a confirmed and agreed upon
next step for each client.
Practice creating constructive tension with colleagues or your manager
in role plays to prepare for customer calls.

The inventors, through their research, have found that high performance is the combination of attitudes, skills/behaviors, knowledge, and activities (e.g., related to the process of developing/retaining customers and making sales) that explain the differences between people who are currently performing at a high level and their less successful peers. The methods and systems described herein provide for managers to assess their direct reports on whether they were more or less likely to exhibit certain sales-related attitudes, skills/behaviors, knowledge, and process activities. For example, approximately 44 attributes were investigated. The results from 683 sales representatives assessed by their direct managers from across 23 companies reveal consistent results across industries and sales cultures differentiating sales reps into one or another of the five different sales rep profile types.

Four general areas are investigated, as shown in TABLE 3:

TABLE 3
AREAS OF INVESTIGATION

Attitudes:
How likely or unlikely are the following to put discretionary effort into
their work, always be willing to go the extra mile, or look for ways to
be better at their job?
Skills/Behaviors:
It more difficult sales situations, how effective or ineffective is each
individual at being able to pressure the customer to make a decision?
Knowledge:
How likely or unlikely is it that the individuals named below are true
experts in the products and services you sell, comfortably exceeding
the knowledge that any expert purchaser might have?
Activities/Process:
How reliable or unreliable is each individual, in terms of their
likelihood to follow the sales process?

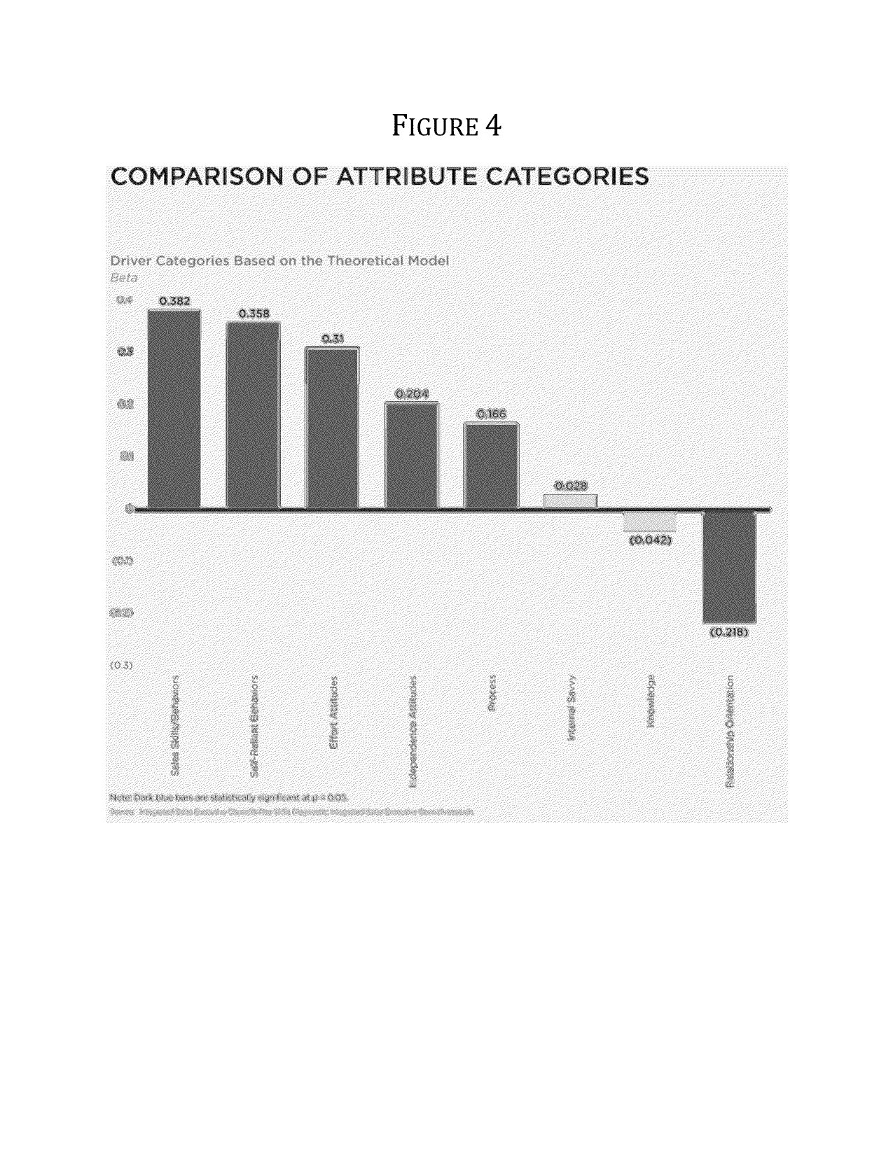

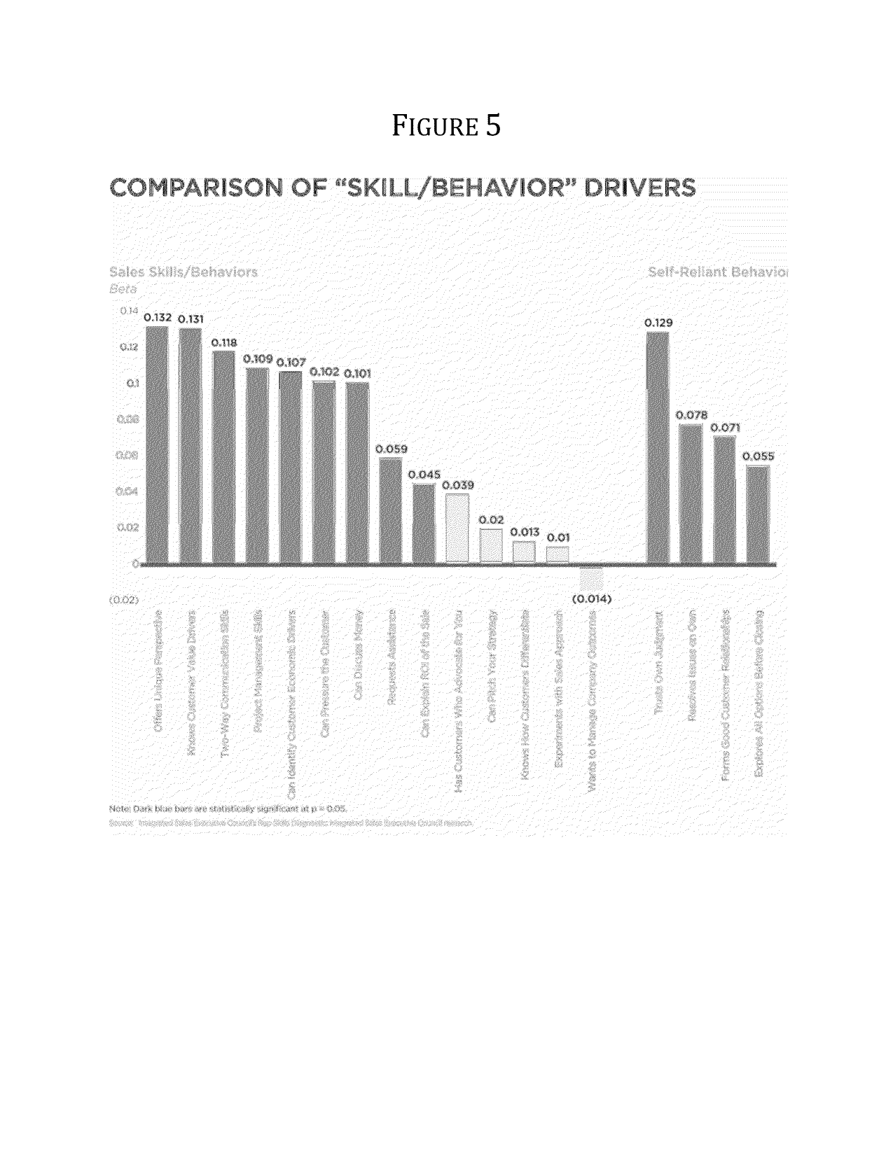

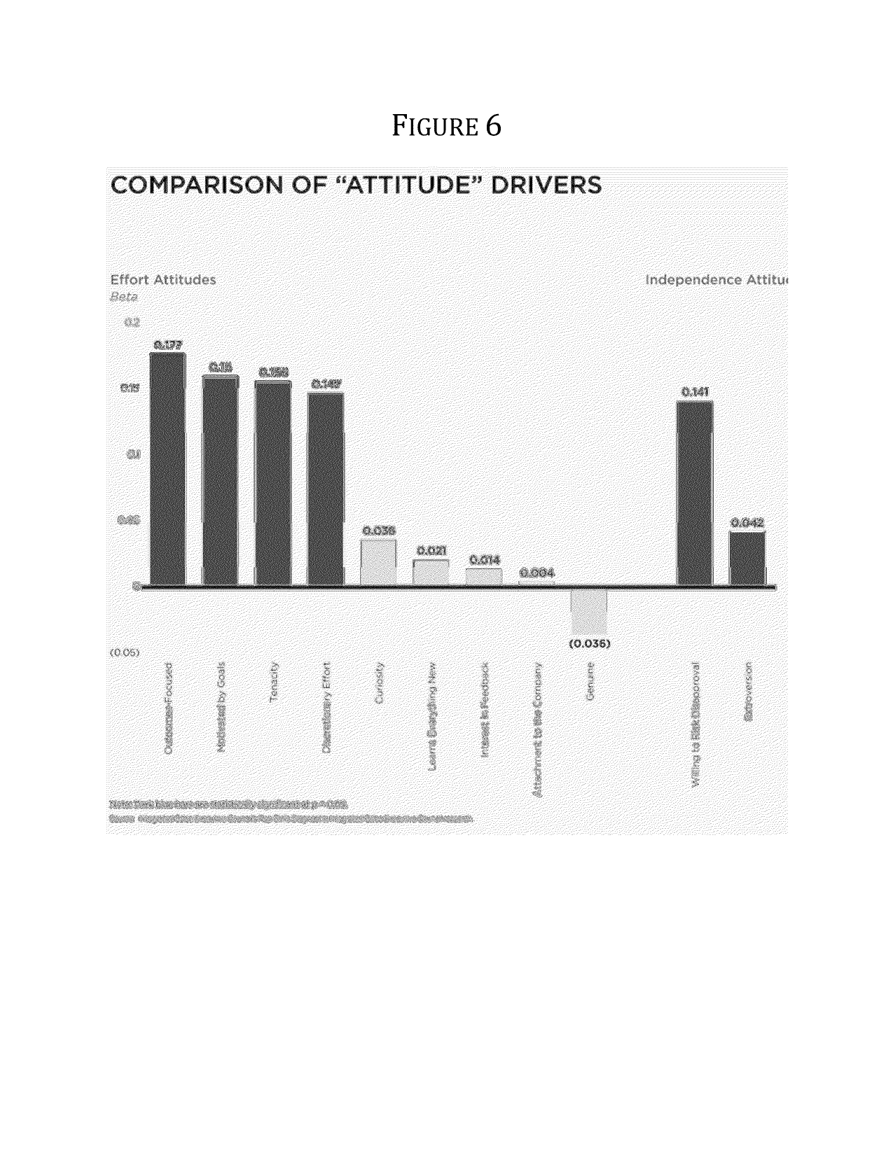

Analysis at the level of the different attributes produced seven different dimensions with varying degrees of importance. Those are Sales Skills/Behaviors; Self-Reliant Behaviors; Effort Attitudes; Independence Attitudes; Process; Internal Savvy; Knowledge; and Relationship Orientation. FIG. 4 shows a chart displaying the beta, or impact on performance of a one unit change in each category of attributes. Most important are those attributes classified under “Skills/Behaviors.” In general, a greater impact is observed when attributes were analyzed in groups than when they were analyzed individually. Taken individually, many of the most important behavior/skills are also those attributes that show up in the Challenger profile. FIG. 5 shows a chart displaying a comparison of the following skill/behavior drivers: Offers Unique Perspective; Knows Customer Value Drivers; Two-Way Communication Skills; Project Management Skills; Can Identify Customer Economic Drivers; Can Pressure the Customer; Can Discuss Money; Requests Assistance; Can Explain ROI of the Sale; Has Customers Who Advocate for You; Can Pitch Your Strategy; Knows How Customers Differentiate; Experiments with Sales Approach; Wants to Manage Company Outcomes; Trusts Own Judgment; Resolves Issues on Own; Forms Good Customer Relationships; and Explores All Options before Closing. Not surprisingly, intrinsic and external motivations are important. Additionally—and likely the result of success rather than anything else—high performers demonstrate higher levels of confidence and independence. The Effort drivers, in particular, are most predictive in their absence. Thus, while high levels of drive are somewhat correlated with high performance and absence of drive correlates very well with low performance. FIG. 6 shows a chart displaying a comparison of the following attitude drivers: Outcomes-Focused; Motivated by Goals; Tenacity; Discretionary Effort; Jury Acidly; Learns Everything New; Interest in Feedback; Attachment to the Company; Genuine; Willing to Risk Disapproval; and Extroversion.

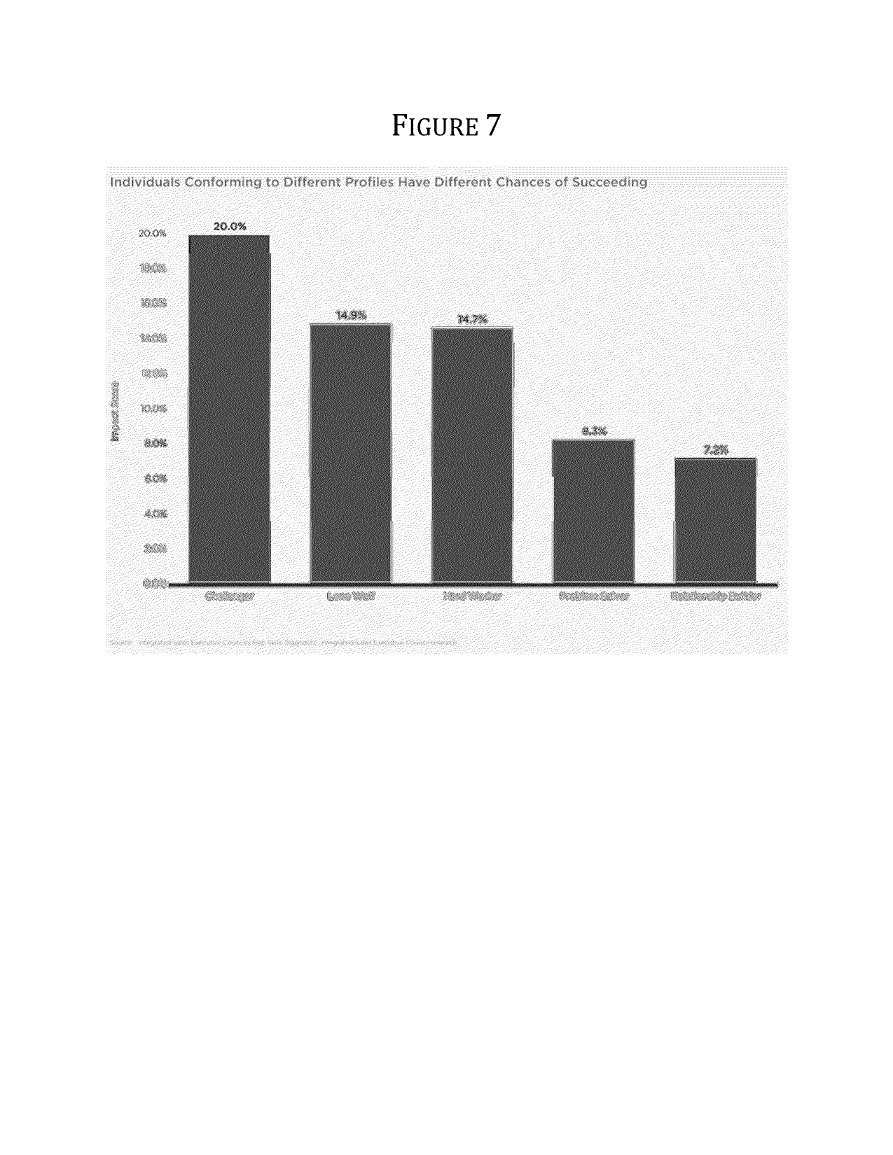

The driver analysis is augmented by factor analysis to determine underlying groupings. Factor analysis was used to separate the attributes into groups of strength that tend to be expressed concurrently. This allowed all sales reps to be slotted into one of the five profiles. FIG. 3 shows the dimensions that individuals with different profiles were most likely to spike in. Scoring highly in the Challenger profile attributes has a much higher impact on success than scoring well in the other profiles. FIG. 7 shows a chart displaying the impact on performance of moving from the 25th to the 75th percentile in the attributes of each profile. A movement from the 25th to the 75th percentile in Challenger attributes yields a 20% improvement in sales performance.

The following discussion relates to specific numerical algorithms and/or correlative techniques used to define the several profiles types discussed herein.

Factor analysis was used to define an underlying structure of a data matrix containing survey responses. R-factor analysis was deployed to identify any latent dimensions as the primary concern was to identify correlations rather than distances among the respondents' scores. The factor analysis is preferably conducted on the skills scores as these are assumed to be homogenous across the entire sample.

Principal Components Analysis was used in order to understand the variance of the entire sample. Subsequently, Varimax was used to maximize the sum of variances of loadings of the factor matrix and to produce a rotated factor matrix.

For each respondent, factor scores were calculated. To do this, the system standardized each variable score and then multiplied this by the corresponding standardized coefficient.

It was then possible to calculate each respondent was to be placed in a profile by identifying the maximum factor score for each respondent. Five linear regressions were then run using the 5 factor scores as the dependent (criterion) measure and the competency scores as the independent measures. This allows isolation of the coefficients that can be used to replicate the initial analysis.

Re-Scoring

Subsequent test takers are then rescored using these new coefficients. This takes the form of the following equation:

FactorScore 1=(coefficient1.1)(questionresponse1)+(coefficient1.2)(questionresponse2)+ . . . +(coefficient N.n)(questionresponse N).

. . . FactorScore 5=(coefficient2.1)(questionresponse1)+(coefficient2.2)(questionresponse3)+ . . . +(coefficient N.n)(questionresponse N).

By identifying the factor where each respondent scores the highest, the system is thus able to continue to profile independent respondents without needing to rerun the analysis every time a new respondent is added to the database.

In addition to receiving responses to a survey from managers or other individuals with knowledge of the individual (sales) professional's work, the methodology in accordance with the present invention may also employ self-assessment techniques and data. In this case, a self-assessment may comprise an on-line or “pen and paper” test or survey that measures how a professional may see or envision themselves. In one possible implementation the self-assessment may adopt a forced choice triplet design where items are presented in blocks of three statements and respondents are asked to indicate which of the three statements best describe them. A forced choice design provides good resistance to response biases often associated with a self-report rating scale design, especially when the assessment is conducted in a high-stakes situation with considerable risk of impression management.

It is noted that regardless of respondents' true behavioral preferences, some behavior statements are generally perceived as more attractive simply because they are more socially desirable. In a forced choice questionnaire design, if items that show large differences in terms of social desirability are combined into the same forced choice triplet, respondents would be biased towards choosing the more desirable items, hence masking their true behavioral preferences. Items combined into triplets are therefore preferably balanced in terms of social desirability. It is noted that the foregoing self-assessment approach may be considered a form of a situational judgment test.

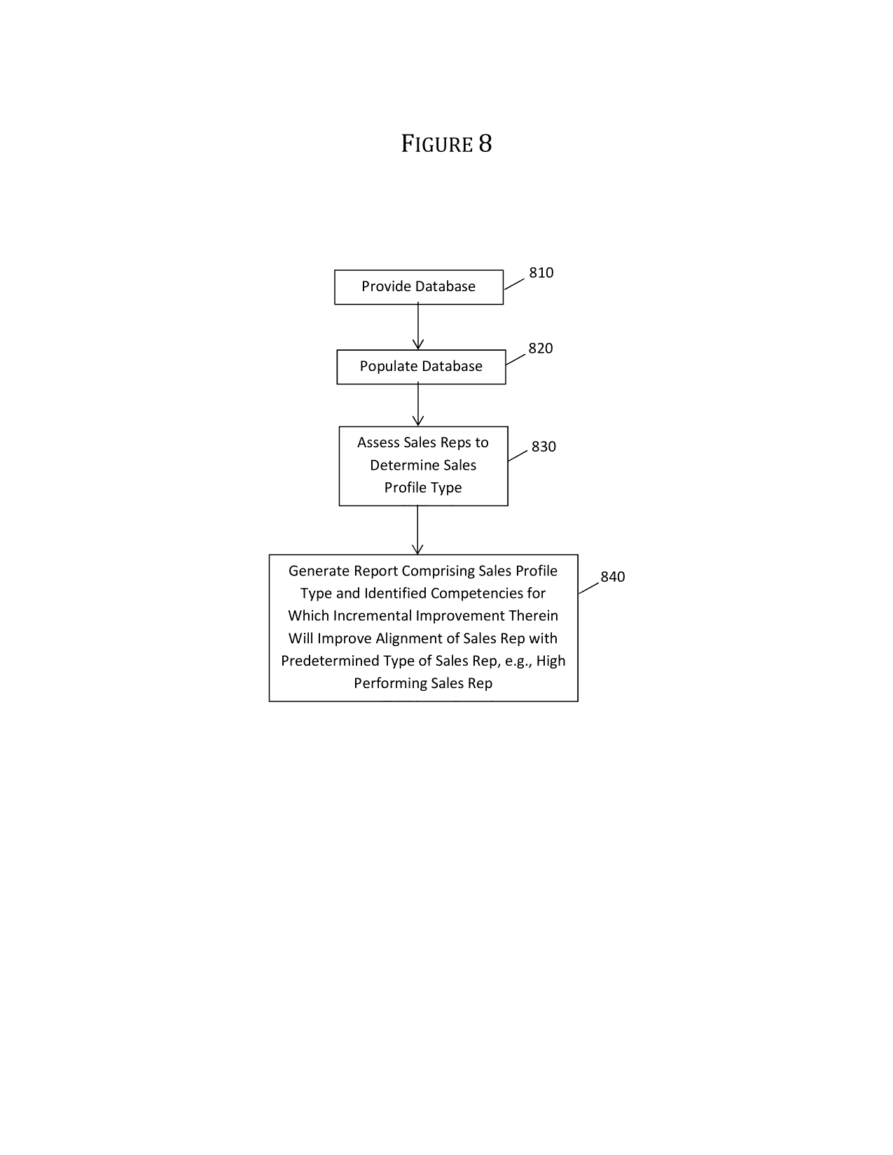

Reference is now made to FIG. 8, which shows another general approach in accordance with the methodology described herein. At 810 a database provided, allocated, or configured, etc. to be consistent with, e.g. the structure shown in FIG. 1B. That is, a plurality of sales rep records is initialized. At 820, the database is populated with data about individual sales reps. The information may be gleaned from the responses given in connection with survey questions like those depicted in FIGS. 2A-2U, responses provided during a self-assessment as described above, and/or weighted combinations of such responses.

At 830, using the populated database, the individual sales reps are assessed to determine their respective sales profile type. The determined profile type can be stored in a field of the sales rep record as indicated in FIG. 1B. Then, at 840, the methodology is designed to generate a report comprising the sales profile type for one or more sales reps and, e.g., identified competencies for which incremental improvement therein will improve alignment of a given sales rep with a predetermined profile type, e.g., a high performance sales rep such as a Challenger type sales rep.

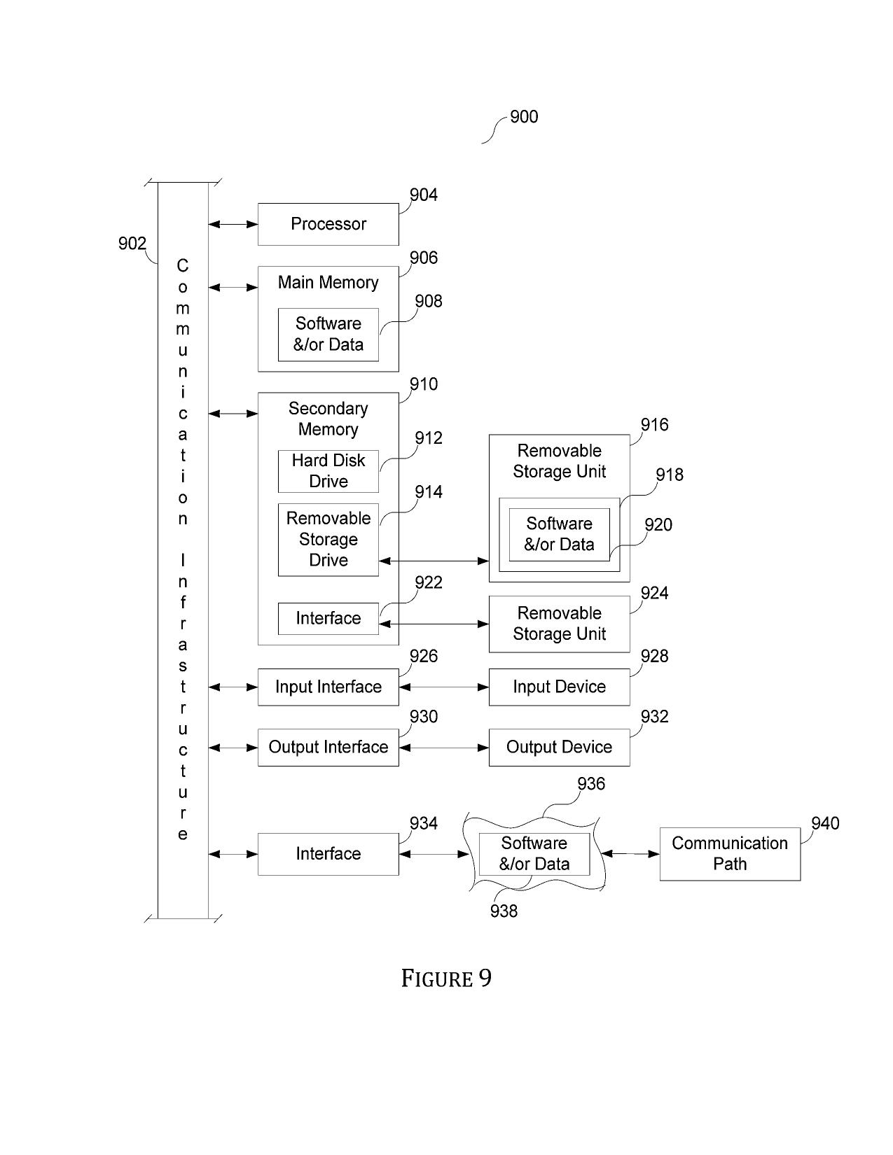

Various aspects of the present invention can be implemented by software, firmware, hardware, or any combination thereof. FIG. 9 illustrates an example computer system 900 in which the present invention, or portions thereof can be implemented as computer-readable code, logic, instructions and the like. Various embodiments of the invention may be implanted using this example computer system 900. It will become apparent to a person skilled in the relevant art how to implement the invention using other computer systems and/or computer architectures. Computer system 900 may be a server or other electronic device or appliance configured to operate in accordance with the functionality described herein.

Computer system 900 includes one or more processors, such as processor 904. Processor 904 can be a special purpose processor or a general purpose processor. Processor 904 is connected to a communication infrastructure 902 (for example, a bus or a network).

Computer system 900 also includes a main memory 906, preferably Random Access Memory (RAM), containing possibly inter alia computer software and/or data 908.

Computer system 900 may also include a secondary memory 910. Secondary memory 910 may include, for example, a hard disk drive 912, a removable storage drive 914, a memory stick, etc. A removable storage drive 914 may comprise a floppy disk drive, a magnetic tape drive, an optical disk drive, a flash memory, or the like. A removable storage drive 914 reads from and/or writes to a removable storage unit 916 in a well known manner. A removable storage unit 916 may comprise a floppy disk, magnetic tape, optical disk, etc. which is read by and written to by removable storage drive 914. As will be appreciated by persons skilled in the relevant art removable storage unit 916 includes a computer usable storage medium 918 having stored therein possibly inter alia computer software and/or data 920.

In alternative implementations, secondary memory 910 may include other similar means for allowing computer programs or other instructions to be loaded into computer system 900. Such means may include, for example, a removable storage unit 924 and an interface 922. Examples of such means may include a program cartridge and cartridge interface (such as that found in video game devices), a removable memory chip (such as an Erasable Programmable Read-Only Memory (EPROM), or Programmable Read-Only Memory (PROM)) and associated socket, and other removable storage units 924 and interfaces 922 which allow software and data to be transferred from the removable storage unit 924 to computer system 900.

Computer system 900 may also include an input interface 926 and a range of input devices 928 such as, possibly inter alia, a keyboard, a mouse, etc.

Computer system 900 may also include an output interface 930 and a range of output devices 932 such as, possibly inter alia, a display, one or more speakers, printing apparatus, etc.

Computer system 900 may also include a communications interface 934. Communications interface 934 allows software and/or data 938 to be transferred between computer system 900 and external devices (including those operated by, e.g. survey participants, managers, system operators, etc.). Communications interface 934 may include a modem, a network interface (such as an Ethernet card), a communications port, a Personal Computer Memory Card International Association (PCMCIA) slot and card, or the like. Software and/or data 938 transferred via communications interface 934 are in the form of signals 936 which may be electronic, electromagnetic, optical, or other signals capable of being received by communications interface 934. These signals 936 are provided to communications interface 934 via a communications path 940. Communications path 940 carries signals and may be implemented using wire or cable, fiber optics, a phone line, a cellular phone link, a Radio Frequency (RF) link or other communications channels.

As used in this document, the terms “computer program medium,” “computer usable medium,” or “computer readable medium” generally refer to media such as removable storage unit 916, removable storage unit 924, and a hard disk installed in hard disk drive 912. Signals carried over communications path 940 can also embody the logic described herein. Computer program medium and computer usable medium can also refer to memories, such as main memory 906 and secondary memory 910, which can be memory semiconductors (e.g. Dynamic Random Access Memory (DRAM) elements, etc.). These computer program products are means for providing software to computer system 900.

Computer programs (also called computer control logic) are stored in main memory 906 and/or secondary memory 910. Computer programs may also be received via communications interface 934. Such computer programs, when executed, enable computer system 900 to implement the present invention as discussed herein. In particular, the computer programs, when executed, enable processor 904 to implement the processes of aspects of the present invention. Accordingly, such computer programs represent controllers of the computer system 900. Where the invention is implemented using software, the software may be stored in a computer program product and loaded into computer system 900 using removable storage drive 914, interface 922, hard drive 912 or communications interface 934.

The invention is also directed to computer program products comprising software stored on any computer useable medium. Such software, when executed in one or more data processing devices, causes data processing device(s) to operate as described herein. Embodiments of the invention employ any computer useable or readable medium, known now or in the future. Examples of computer useable mediums include, but are not limited to, primary storage devices (e.g., any type of random access memory), secondary storage devices (e.g., hard drives, floppy disks, Compact Disc Read-Only Memory (CD-ROM) disks, Zip disks, tapes, magnetic storage devices, optical storage devices, Microelectromechanical Systems (MEMS), nanotechnological storage device, etc.), and communication mediums (e.g., wired and wireless communications networks, local area networks, wide area networks, intranets, etc.).

### Representative Examples

Representative examples will now be set forth in order to present some of the beneficial results of the systems and methods described:

### Example 1

### Building a Challenger Sales & Marketing Organization at Company R

Company R, historically the market leader in its industry, began feeling greater competitive pressures from Company P in terms of product features and market share. Revenue growth had hit a plateau. Many Territory Managers (front-line salespeople) had just missed goal for the first time. Company P had closed the gap in terms of product innovation. In short, Company R realized that they could no longer rely on their product alone to lead their commercial organization.

Sales leadership wanted to cement Company R's competitive advantage with improvements across sales techniques and marketing. Using the methods and systems described herein, front-line sales and managers participated in two surveys: the Challenger Manager Downward assessment and the Challenger Winning Messages survey. The first identified the sales profile mix of the Territory Managers, and the other identified the prevalence and success of winning messages to customers.

Results showed that Regional Managers were much more optimistic about their Territory Managers' skills than the Territory Managers were about their own skills. Some specific areas for organizational improvement were: offering a unique perspective, understanding customer value drivers and discussing pricing and money. Also, surveys showed that Territory Managers continued to have product-led conversations despite the diminishing effectiveness of those conversations.

The survey results and analysis reports were used by marketing to create sales scripts for front-line sales (Territory Managers), and to customize content for their National Sales Meeting. Front-line and territory managers also participated in Coaching to the Challenger training, identified as being likely to provide sales performance enhancement for Company R's sales culture. Using the training, Challenger insights were identified.

For the first quarter following the training, earnings were up 16% YOY. During follow-up calls over the next 3 months, Territory Managers from every area shared early successes from using the Challenger model. For example: “Doubled our normal business with them” TO, NE; “Saved a $115 k a year business, plus new resupply revenue” SS, SE; “Sold 100 product 1s and 200 product 2s despite their loyalty to a competitor.”

The quarter following the training, Company R posted its best quarter in history. Total revenue grew 9% over the same quarter the previous year. Each area had numerous success stories of improved business due to following the Challenger model. SS had a customer that was considering a shift to online. By using the Challenger approach, he was able to establish a true business partnership and save a $115 k/year account. TO was able to double his business to $200 k in the quarter with a hospital-owned HME. PV was able to overcome a hostile customer who threatened to stop doing business with Customer R; and, he not only preserved but actually increased their market share. ME increased his business with one customer by $300 k annually. Each area had success stories, which were shared across the organization to drive further adoption of the Challenger process.

Two Company R case studies follow:

Case Study 1: PB and Customer A

PB has been a Territory Manager and Regional Sales Trainer with Company R for 7 years. Customer A is a top 5 customer in Southern California for Company R. They are a hybrid account with over 20 medical care units, with a growth of 39% QoQ and even greater potential. Ideally, Customer A could do over $60 k in business a month with Company R alone, although they are currently only doing $66 k per quarter. Before the Challenger training, PB would lead sales calls with descriptions of Company R solutions and products.

PB brainstormed with his manager, who, leveraging the pre-call questions from the Coaching Guide, helped identify several key pain points for Customer A. Specifically, they were losing revenue on their existing patients, over 9,000 active and inactive patients in their database. They wanted to quantify how many were compliant to determine the upside potential. Also, they noted that Customer A was losing replenishment revenue to internet leakage, and not maximizing the potential revenue for consumables and accessories.

PB and his manager visited Customer A for their semiannual business review. They had two individuals to consider in their tailoring. NA, the Director of DME and Replenishment, is an Influencer and strong advocate for Company R. The CEO, FZ, on the other hand, is an analytical/driver personality and new to the business. PB had to be delicate in identifying pain points as to not make NA look bad in front of his CEO.

Using the Challenger approach, PB was able to achieve a win-win solution with Customer A. PB increased his total sales with Customer A from $66 k to $162 k a quarter. He attributes this gain to the new approach of tailoring the discussion to the business, instead of leading with products. Since the call, FZ said that he prefers the new approach of working with business partners looking to help their business grow.

Case Study 2: MF and DH with Customer S

MF is a Regional Manager and DH is a Corporate Accounts Manager at Company R. Historically, Company R had a 60% share with Customer S, selling over 600 products in previous years. After some issues with the current model, Customer S began to shift the majority of their flow generator business to cheaper units from Company P. The run rate for Company R for FY 2011 was heading for less than 375 units to Customer S.

Following the model from the Challenger training, DH gathered statistics about Customer S to identify a number of pain points—chiefly internet leakage. He also estimated the lifetime value of a compliant patient and prepared a plan to grow Customer S's business. This included the benefits of how Company R's internet pricing policy would protect the future revenue from Customer S's installed patient base, assistance on setting up a Home Testing program, and training for the sales people. He also carefully reviewed the Customer S website, noting their internet program around replacement.

DH had a meeting with Customer S CEO JL and store manager LS. DH's goal was to regain primary status with Customer S by focusing on developing a business partnership. DH was able to show that only by selling Customer R products could Customer S assure that their patients would stay compliant and continue to purchase all of the replacements, consumables, and other products from Customer S, and not turn to cheaper internet alternatives. DH and MF also tailored their discussion to the personalities of JL and LS—influencer and a dominant, respectively—and linked their solution to the described internet replacement program.

Using the Challenger approach, DH and MF were able to achieve a win-win solution with Customer S. Customer S was able to increase their overall revenue 25% YoY, or by $250 k. And Company R was able to regain a commitment to receive 75% share of the Customer S business. Together with the increase in Customer S business, Company R showed improved account revenue by $300 k YoY.

### Example 2

### Case Study

### Company 1

Every year Customer 1 would subscribe to Company 1's standard support package for roughly $199,000 a year. Customer 1 never had the desire to move to premium support due to the “sticker shock” over the higher price. Company 1 gave a premium support benefits/value presentation to Customer 1 but still failed to land the sale using their then-current techniques. Using the systems and methods described herein, TK, an inside account manager with Major Accounts at Company 1 was identified as a sales rep who would benefit from Challenger-enhancing training, and was thereafter provided the Challenger Training.

Immediately following the training, TK compiled a SWOT/Spoke analysis of Customer 1 and noticed that they had many outstanding projects for the upcoming years. Finding out what Customer 1's pain points were, and what keeps them up at night, revealed to TK Customer 1's incredible sensitivity to turnaround time and finishing projects on time. With this new knowledge, TK decided to schedule a second meeting with the same Customer 1 team to focus on their business concerns and how Company 1 can help them be more productive and efficient.

Initially skeptical, Customer 1 granted the meeting request. Company 1 realized that due to Customer 1's growth in Asia, the Customer 1 US team now had to work closer with the Asia team. Customer 1 also wanted consistency with support matters for both Asia and the US. Customer 1 always resisted premium support because they had expertise in-house and would solve their issues internally. Even though Customer 1 could solve their issues themselves eventually, this method did lead to excessive downtime for certain support issues. Premium support would guarantee 24/7 support from Company 1 to immediately resolve any issues with no downtime—a significant benefit given Customer 1's concerns. Plus, with premium support, Company 1 would routinely check in with Customer 1 to pre-empt any issues in the first place.

Within five days TK had a verbal commitment for a premium subscription at $347,000! Not only did TK win the bigger sale, the relationship with the client drastically improved. MG, Manager at Customer 1 directly attributed the change in heart to the Challenger approach: “This was the first time you focused on the end result, and touched on our pain points.” Not only did TK receive the verbal commitment, but Customer 1 offered to pull the P.O. forward to the current month so Company 1 could book the sale to the current quarter! Furthermore, MG is extremely excited about attending Company 1 support conferences as a premium customer now.

### Example 3

### Case Study

### Company 2

Company 2 faced a very challenging market heading into their upcoming year. Regulatory changes, such as the increasing impact of Competitive Bidding, squeezed their customers' margins. This made a lot of customers hesitant to make even the most prudent investments in their businesses. Company 2 chose to counter this trend by investing in its sales force, and, using the systems and methods described herein, identified their success factors as falling within the Challenger profile type.

Therefore, Challenger-enhancing programs were provided to develop Challenger capabilities and position Company 2 as business advisors instead of just suppliers to their customers. Company 2 used a Train the Trainer model. One Regional Sales Manager, SD, was able to put the Challenger techniques to use soon after training with Customer 2 and achieve a win-win for Company 2 and Customer 2.

Following the Challenger model, SD started with a detailed analysis of Customer 2's business. Doing this, SD learned that they had won a Medicaid contract, but that their current model medical equipment would not be profitable with Medicaid reimbursement rules. In short, Customer 2 would have to adapt their business model. SD then crafted an insight focused on this pain point for the Challenger conversation. Also, because SD knew of Customer 2's contract with Medicaid, SD knew he could connect the conversation to Customer 2's agenda.

Across the next several meetings with Customer 2, SD built constructive tension by challenging Customer 2 to partner with Company 2 to use a different model. After establishing the need, SD demonstrated that by adopting a Company 2 Program and using Company 2's leasing options, Customer 2 could ensure profitability while remaining cash positive. Because SD had effectively brought insight around a pain point, quantified it, and connected it to the customer agenda, SD was able to assert control of the sales conversation and keep Customer 2 focused on finding a profitable business model. In the past, SD used to open with a discussion of Company 2 products, which inevitably led right to price discussions. This time, SD focused on solutions and achieved a better result for both Customer 2 and Company 2.

SD and Customer 2 reached an agreement for medical equipment and consumables totaling $1.5M in new business. More importantly, Customer 2 changed their business model to adapt to the needs of Medicaid, ensuring that they stay profitable into the future. SD's new approach ensured that Customer 2 would view Company 2 as a trusted business advisor going forward.

### Example 4

### Building Challengers at Company C

Coming out of the recent recession, Company C was looking for a new strategy. During the downturn, they cut prices, squeezed margins, and took projects that they normally would not have to preserve market share. Although their customer surveys showed that Customer C was widely regarded as the highest quality provider of parts and service in their industry, they were having difficulty commanding their expected premium. Additional research also showed that their customer engagement ratings were slipping.

SR, Vice President of Sales and Marketing for the Americas, used the systems and methods described herein in his consideration of how to respond to these circumstances. Company C front-line sales professionals typically were promoted from the rig team, where they grew accustomed to taking orders from customers. Instead, SR felt that his front-line sales needed to show customers “tough love,” and needed to be able to push back on customers. Later in the winter SE, SR's counterpart in Europe, Africa, Caspian Sea, and Russia (EACR), also saw potential in using the systems and methods described herein and the resultant Challenger-enhancing program.

Company C used a program consisting of five phases: discovery, reporting, front-line manager training, front-line sales training, and a reinforcement program. North America and EACR ran parallel, but separate, programs. Each program was customized to the particulars of their markets.

The results from the methods and systems allowed SR and SE to align the curriculum and the goals. The final output was a highly customized curriculum showing examples of Challenger conversations based on actual Company C sales. Curriculum content and examples were also aligned with Company C's strategic shift toward systems selling.

Training to the front-line managers and front-line sales for the EACR team was conducted over a five-day meeting. Later, two more sets of sessions were conducted for the North America team. The training was also attended by a few product and marketing specialist to align them to the new strategy.

Company C saw record bookings in its systems sales for the third quarter of its current year, after just two of their three regions used the systems and methods herein. Systems revenue rose 28% versus the previous year. Company C CEO JM even stated to investors, “As we have stated on previous calls, we placed a lot of focus on our sales efforts, our facility infrastructure, our personnel and our asset builds to support this market, and the investments are paying off.”

Some executives were more specific in attributing success to the Challenger model. SE, Vice President of Sales and Marketing EACR, attributed $3M of additional revenue (and $1M of profit) directly to the Challenger training in a meeting with JM. SR similarly attributed improved revenues and margins to the Challenger partnership.

### Example 5

### Company N Adopts Challenger Program

Company N used the systems and methods described to determine to launch a Challenger Development Program focused on implementing a Solutions Selling model across the global sales team. Company N reinforced successful behaviors of Top Achieving Account Managers (AMs) and internal best practices across geographies. These aligned to Challenger capabilities.

The model was developed, communicated and implemented using a three-phased approach:
Development and Customization of Program: Company N leadership and HR development teams developed and customized program content in accordance with the recommendations provided by the systems and methods described.
Individual Training and Development Program: AM's receive training on Challenger capabilities, including a set of tools to embed this behavior in their sales activities.
Reinforced by a Sales Manager Coaching: Company N introduced customized coaching tools for Sales Managers and aligned coaching to overall change management efforts.

Company N's implementation efforts resulted in the following:
Sales Productivity: a 9% increase in sales capacity across its Sales Force as a result of focusing AM's on a higher value set of behaviors; average performing AM's dramatically improve their sales approach, signifying a clear replication of Challenger behaviors; 80% of AM population identified opportunities to improve personal levels of productivity.
Customer Centricity: 30% increase in focus placed on understanding customer needs (teaching) and aligning messages to customer pain points (tailoring); 37% improvement in The Team coordination and effectiveness of Account Team member support, with greater alignment in objectives to best meet customer needs.
Manager-Led Coaching: 40% increase in time spent coaching AM's along with a 50% increase in the effectiveness of coaching interactions.

The focus on identifying and developing challengers yields Company N a 21% year-over-year improvement in Return on Sales Productivity (Sales Productivity as measured by Return on Sales Expense (revenue/cost of sales)).

### Example 6

### Alpha Company

While a respected global leader in security-related services, Alpha Company faced increased commoditization of a number of their core business offerings. Customers were indicating that they preferred Alpha Company products, but they were pressured to cut costs wherever possible. In addition, while competitors reduced prices, Alpha Company realized strong customer relationships were no longer winning them business. Many at Alpha Company believed they also had to compete primarily on price to win. Additionally, a history of hiring high performing sales people from other organizations had left Alpha Company with a strong team that had good relationship building skills but lacked a consistent process or approach across the organization. Alpha Company believed they needed to equip their entire sales force with the selling skills that would enable them to differentiate Alpha Company offerings with their customers, not simply build collegial relationships.

The Alpha Company sales organization used the systems and methods described herein to, among other things, administer a “Winning Messages” survey to assess what messages and insights the sales force was currently using with customers, and as a result, determined the profile types of the individual sales reps. Predictably, with no inherent built-in institutional sales culture revealed, the Challenger profile was determined to be the profile most likely to perform highly. Three days of in-depth Challenger training was provided, and the sales reps were given tools to embed critical skills and reinforce learning, as well as structured follow up support. Critical functions, such as operations, marketing, and the entire executive leadership team, were also trained to support Challenger messaging by attending customized workshops for each group and receiving additional guidance as needed.

Alpha Company reported that embedding Challenger skills changed the way they hire, onboard, and train people; the messages that marketing creates; the way that customers respond to Alpha Company sales people; and the velocity of sales in the pipeline. Leadership reports that the sales force now has a consistent sales approach (sales culture) and that operations focuses more effectively on supporting the sales process, rather than just on the technical aspects of the deal. Additionally, Alpha Company leadership has already seen multiple deals that have been saved or won as a direct result of using Challenger skills.

Case Study: Alpha Company Sales Professional 1:

“The week after the training I was on the phone with a senior contact and he said that there was an RFP coming, that they were very unhappy with the relationship, and that we should expect a serious decrease in business. I told him that I understood that there were decisions made but that our hope is to turn that around. I challenged them on some of the recent service decisions they had made and created constructive tension by pushing him on the results. In the past I never would have been so direct and pushed him that way but I was surprised with how well he reacted. We dealt with the elephant head on and dealt with the problem issues in order to find a way forward. Now we're going to be the sole provider for all services that we can provide. This represents $25M in business for us.”

Case Study: Alpha Company Sales Professional 2:

“One potential new customer called us looking for a price quote. They had looked at us in the past and decided we were too expensive. We gave them a price but they had a consultant with them that pushed back and asked us to go lower. We told them no, that's the price, we don't play games, we lead with the best offer and if you're only concerned with price, our conversation is over. The customer then asked ‘Why should I do business with Alpha Company?’ We were able to educate him about his business and some of the other challenges they were having and illustrate how Alpha Company could solve them in a unique way that was different from the competition. We won the work despite being the highest bidder!”

### Example 7

### Beta Company

In response to the recent global economic decline, leading medical device company, Beta Company Inc., faced pricing pressures from customers who were looking to lower risk tolerance by cutting operating costs. As customers began expecting generous concessions in exchange for new business; this market leader soon realized that they were entering into an increasing amount of competitive deals and quickly began losing market share to the competition. In order to effectively compete in this new marketplace, they needed a new approach to bring value into their customers' purchasing process.

Beta Company used the methods and systems described herein to better understand the current sales culture and profiles of their sales representatives, and the messages that they were delivering to the market. The outcome was a determination to develop more Challenger type skills throughout sales leadership, managers, and reps to lead the change and adoption of new skills that drive customer value. Beta Company is continuing to provide customers with increased value during the purchasing process to ensure their customers, patients, and caregivers receive the outcomes they need.

As a result of their new customer approach, Beta Company has seen an increase in average price per sale, historically high sales figures; the largest deal in company history; integrated sales and marketing functions that sustain the challenger approach; and high adoption rate of Challenger Selling Model among field sales teams.

### Example 8

### Gamma Company

Backed by the US government as a preferred provider, Gamma Company, a leading US mortgage insurer, faced tremendous external pressure in the economic downturn. Heavily affected by the US mortgage crisis, sales professionals faced limitations in their ability to sell effectively and differentiate themselves due to new government laws and regulations. When regulations began to loosen, and sales professionals regained autonomy in their selling approach, Gamma soon realized that they were losing deals to competitors who provided more flexibility in their offerings. In this new environment, it is necessary that sales professionals be better at identifying customers' challenges, articulating Gamma's value proposition to overcome this competition and build urgency with customers. Front line and regional managers play a critical role in leading and sustaining any change efforts.

The Gamma Company's sales organization used the systems and methods described herein to identify skill disparities between average and high performing sales reps and managers through an online survey. As a result, an integrated development program that instructed sales reps to teach, tailor, and take control of the commercial experience was implemented. Furthermore, the leadership and coaching capabilities of front line and regional managers were reinforced through frequent training events and teleconferences.

Gamma has improved the way their sales reps engage their customers and have seen increased Market Share (by 200%) in a down economy; high levels of skill adoption post workshop; managers successfully coaching to Challenger selling approach; and much better cross-functional alignment between Sales, Marketing, and HR functions.

It will thus be seen that the objects set forth above, among those made apparent from the preceding description, are satisfactorily attained and, since certain changes may be made in carrying out the above method and in the systems set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall there between.

What is claimed is (claims begin on the next page):

What is claimed is:

1. A computerized method for assessing and enhancing the sales performance of selected sales force professionals, comprising the steps of:
a. providing a computerized database for storing a plurality of sales rep records, each sales rep record including one or more dimensions for storing associated dimension scores;
b. populating said database with dimension scores representative of a plurality of sales reps, including dimension scores representative of a high-performing sales rep;
c. assessing, with a processor, each sales rep record from among the plurality of sales rep records yielding assessed sales reps by comparing dimension scores of each sales rep record to the dimension scores representative of a high performing sales rep to determine a sales profile type of each sales rep, and, for a given sales rep, whether any dimension scores for said given sales rep meet or exceed a value indicative of a high performing sales rep; and
d. generating, based on the sales rep records, one or more computerized reports comprising one or more indicators of sales profile type associated with respective assessed sales reps, one or more indicators of specific dimensions for said respective assessed sales reps representing those dimensions which by incremental improvement in the associated dimension scores will improve alignment of said respective assessed sales reps with said high-performing sales reps in view of sales profile type for said respective assessed sales reps.

2. The computerized method of claim 1, wherein said dimensions further comprise:
a dimension selected from among the dimension types comprising objective dimensions, subjective dimensions, and dimensions derived from a combination of other dimensions.

3. The computerized method of claim 1, wherein at least one of said indicators comprises:
a dimension score for a dimension derived from a combination of other dimensions and meeting or exceeding a predetermined value indicative of the high-performing sales rep.

4. The computerized method of claim 1, wherein the step of generating a computerized assessed sales rep record further comprises:
conducting a computerized survey of a plurality of sales reps to be assessed by obtaining normalized relative dimension scores for some or all of said assessed sales reps from one or more survey participants having individual knowledge of, and experience with, each assessed sales rep such survey participant assesses, and wherein each of said plurality of sales reps to be assessed are assessed by at least one of said survey participants.

5. The computerized method of claim 4, wherein the step of conducting a survey further comprises:
simultaneously assessing each said assessed sales rep to be assessed relative to each other along a uniform, normalized scale by presenting to a survey participant a survey question seeking dimension scores for each such assessed sales rep to be assessed at the same time.

6. The computerized method of claim 1, further comprising:
populating the computerized database with sales rep records comprising sales rep records including at least one objective dimension indicative of high performance, and wherein at least one sales rep record includes a dimension score meeting or exceeding a value indicative of a high performing sales rep.

7. The computerized method of claim 6, wherein at least one objective dimension indicative of high performance comprises:
an objective measure of sales performance success selected from among: gross sales, net sales, profit attainment, percent of sales targets met, and derived combinations thereof.

8. The computerized method of claim 1, further comprising:
populating the computerized database with sales rep records comprising each sales rep record from the plurality of sales reps to be assessed, and including at least one objective dimension indicative of high performance, and wherein at least one sales rep record includes a dimension score meeting or exceeding a value indicative of a high performing sales rep.

9. The computerized method of claim 8, wherein at least one objective dimension indicative of high performance comprises:
an objective measure of sales success selected from among: gross sales, net sales, profit attainment, percent of sales targets met, and derived combinations thereof.

10. The computerized method of claim 1, wherein the sales profile types consist essentially of the profile types:
challenger, lone wolf, hard worker, problem solver, and relationship builder.

11. The computerized method of claim 1, wherein the computerized reports further comprise:
one or more indicators of a selected course of action to be followed in order to effect incremental enhancement of said assessed sales reps in the associated dimension scores indicative of a high performing sales rep.

12. The computerized method of claim 1, further comprising administering respective self-assessments to the plurality of sales reps.

13. The computerized method of claim 12, wherein said assessing comprises analyzing results of the respective self-assessments in combination with assessments made by personnel having individuals knowledge of, and experience with, respective sales reps.

14. The computerized method of claim 12, wherein said administering comprises presenting questions in the form of a forced choice triplet.

15. The computerized method of claim 1, wherein said assessing comprises analyzing the assessed sales reps in view of a company-wide profile type and an industry-wide profile type.

16. One or more computer readable storage media encoded with instructions comprising computer executable instructions and when the instructions are executed are operable to:
a. access a computerized database for storing a plurality of sales rep records, each sales rep record including one or more dimensions for storing associated dimension scores;
b. populate said database with dimension scores representative of a plurality of sales reps, including dimension scores representative of a high-performing sales rep;
c. assess each sales rep record from among the plurality of sales rep records yielding assessed sales reps by comparing dimension scores of each sales rep record to the dimension scores representative of a high performing sales rep to determine a sales profile type of each sales rep, and, for a given sales rep, whether any dimension scores for said given sales rep meet or exceed a value indicative of a high performing sales rep; and
d. generate, based on the sales rep records, one or more computerized reports comprising one or more indicators of sales profile type associated with respective assessed sales reps, one or more indicators of specific dimensions for said respective assessed sales reps representing those dimensions which by incremental improvement in the associated dimension scores will improve alignment of said respective assessed sales reps with said high-performing sales reps in view of sales profile type for said respective assessed sales reps.

17. The computer readable storage media of claim 16, wherein each of said dimensions further comprise a dimension selected from among the dimension types comprising objective dimensions, subjective dimensions, and dimensions derived from a combination of other dimensions.

18. The computer readable storage media of claim 16, wherein each of said indicators of high performance further comprises:
a dimension score for a dimension derived from a combination of other dimensions and meeting or exceeding a predetermined value indicative of a high-performing sales rep.

19. The computer readable storage media of claim 16, wherein when the instructions are executed are further operable to:
conduct a computerized survey of a plurality of sales reps to be assessed by obtaining normalized relative dimension scores for some or all of said assessed sales reps from one or more survey participants having individual knowledge of, and experience with, each assessed sales rep such survey participant assesses, and wherein each of said plurality of sales reps to be assessed are assessed by at least one of said survey participants.

20. The computer readable storage media of claim 19, wherein when the instructions are executed are further operable to:
simultaneously assess each said assessed sales rep to be assessed relative to each other along a uniform, normalized scale by presenting to a survey participant a survey question seeking dimension scores for each such assessed sales rep to be assessed at the same time.
